(19) United States
(12) Patent Application Publication
(10) Pub. No.: US 2015/0259500 A1
(43) Pub. Date: Sep. 17, 2015

(54) PREPARATION OF FOAM MATERIALS DERIVED FROM RENEWABLE RESOURCES

(71) Applicant: The Procter & Gamble Company, Cincinnati, OH (US)

(72) Inventor: John Collins Dyer, Evendale, OH (US)

(21) Appl. No.: 14/725,669

(22) Filed: May 29, 2015

Related U.S. Application Data
(63) Continuation of application No. 12/913,090, filed on Oct. 27, 2010, now abandoned.

(51) Int. Cl. C08J 9/28; C08F 220/18

(52) U.S. Cl. CPC C08J 9/283; C08F 220/18; C08J 2333/10; C08J 2333/08; C08J 2201/028; C08F 2220/1858; C08J 2333/06

(57) ABSTRACT

Monomers and crosslinkers derived from renewable resources that can be used to produce flexible, microporous, open-celled polymeric foam materials having physical characteristics making them suitable for a variety of uses, are disclosed. Monomer compositions derived from renewable resources, and having short curing times for preparing foam materials from high internal phase emulsions are also disclosed.

### FIELD OF THE INVENTION

The present invention relates to monomers and polyfunctional crosslinkers derived from renewable resources that can be used to produce microporous, open-celled polymeric foam materials having physical characteristics making them suitable for a variety of applications, such as in absorbent articles.

### BACKGROUND OF THE INVENTION

An emulsion is a dispersion of one liquid in another liquid and one form is a water-in-oil mixture having a water phase dispersed within a substantially immiscible continuous oil phase. Water-in-oil (or oil-in-water) emulsions having a high ratio of dispersed water phase to continuous oil phase are known in the art as High Internal Phase Emulsions, also referred to as “HIPE” or “HIPEs.” At relatively high dispersed water phase to continuous oil phase ratios, the continuous oil phase becomes essentially a thin film separating and coating the droplet-like structures of the internal, dispersed water phase. In certain HIPEs, the continuous oil phase comprises one or more polymerizable monomers and one or more polyfunctional crosslinkers. These monomers can be polymerized and crosslinked, forming a cellular structure, for example a foam, having a cell size distribution defined by the size distribution of the dispersed, water phase droplets.

HIPEs foams can be formed in a continuous process, wherein a HIPE is formed and then moved through the various stages used to produce a HIPE foam. A movable support member, such as a belt, typically is used to move a HIPE from one stage to the next. Initially, about 10% to about 20% of the monomers present in the oil phase are polymerized to form the HIPE. Then, a bulk polymerization of the monomers present in the oil phase occurs to produce a HIPE foam. The bulk polymerization stage lasts until about 85% to about 95% of the monomer has been polymerized into a HIPE foam.

An initiator to start polymerization generally is added during HIPE formation, either to the dispersed water and continuous oil phases, or to the HIPE itself during the emulsion preparation process. In addition to the presence of an initiator, exposure of the forming emulsion to heat or ultraviolet radiation can be used to accelerate the polymerization reaction. In a continuous process following HIPE formation, a HIPE can be moved to a multi-tiered curing oven, which is an oven having a belt running in the opposite direction from the belt above or below it, to complete polymerization.

Other methods for producing HIPE foams include (i) pouring the HIPE into a large holding vessel, which then is placed in a heated area for curing in multiple stages (U.S. Pat. Nos. 5,250,576; 5,189,070; 5,290,820; and 5,252,619, each incorporated herein by reference), and (ii) placing the emulsion on a layer of impermeable film, which then is coiled, placed in a chamber, and cured using a sequential temperature sequence (U.S. Pat. Nos. 5,670,101; 5,189,070; 5,290,820; 5,252,619; and 5,849,805, each incorporated herein by reference). Two methods that allow the formation of a HIPE foam in a short period of time are described in International Patent Application Publication No. WO 00/50498 and U.S. Pat. No. 6,274,638, each incorporated herein by reference. U.S. Pat. No. 6,365,642, incorporated herein by reference, discloses a rapid and efficient process for preparing open-celled polymeric HIPE foam materials with desired properties without the use of complex assemblies or added steps.

The development of microporous foams is the subject of substantial commercial interest. Such foams have found utility in various applications, such as thermal, acoustic, electrical, and mechanical (e.g., for cushioning or packaging) insulators; absorbent materials; filters; membranes; floor mats; toys; carriers for inks, dyes, lubricants, and lotions; and the like. Uses and properties of foams, are described in references including Oertel, G., “Polyurethane Handbook”; Hanser Publishers: Munich, 1985, and Gibson, L. J.; Ashby, M. F., “Cellular Solids. Structure and Properties”; Pergamon Press: Oxford, 1988. Other uses for foams are generally known to one skilled in the art.

Open-celled foams prepared from high internal phase emulsions are particularly useful in a variety of applications including absorbent disposable articles (U.S. Pat. Nos. 5,331,015; 5,260,345; 5,268,224; 5,632,737; 5,387,207; 5,786,395; 5,795,921), insulation (thermal, acoustic, mechanical) (U.S. Pat. Nos. 5,770,634; 5,753,359; 5,633,291), filtration (Bhumgara, Z. Filtration & Separation March 1995, 245-251; Walsh et al. J Aerosol Sci. 1996, 27, 5629-5630; published PCT application W/O97/37745), and various other uses. The cited patents and references above are incorporated herein by reference.

Most of the materials used to produce HIPE foams are derived from non-renewable resources, such as petroleum and coal. Typically, the reactive monomers used for the production of HIPE foams include C₂-C₁₈ alkyl (meth)acrylates or aryl (meth)acrylates, polyfunctional crosslinking acrylates, polyfunctional crosslinking methacrylates, and polyfunctional crosslinking acrylate methacrylates, and are present in an amount of up to 97 wt. % of the HIPE foam. These monomers are derived from (meth)acrylic acid and alcohols which are obtained directly from petroleum via cracking and refining processes. Propylene derived from petroleum is also used to prepare acrylic acid via a catalytic oxidation process. Acrylic acid derived from petroleum is the major feedstock used in the manufacture of current commercial HIPE foams.

Thus, the price and availability of the petroleum and coal feedstock ultimately have a significant impact on the price of HIPE foams. As the worldwide price of petroleum and/or coal escalates, so does the price of HIPE foams. Furthermore, many consumers display an aversion to purchasing products that are derived from petrochemicals. In some instances, consumers are hesitant to purchase products made from limited non-renewable resources (e.g., petroleum and coal). Other consumers may have adverse perceptions about products derived from petrochemicals as being “unnatural” or not environmentally friendly.

U.S. Pat. No. 5,767,168 describes biodegradable and/or compostable polymers prepared from isoprene that are useful in absorbent articles, such as diapers, as well as other biodegradable articles, such as films, and latexes useful as binders and adhesives. However, these polymers are susceptible to autooxidation, thereby diminishing their shelf-life.

Accordingly, it would be desirable to provide HIPE foams using monomers and crosslinkers derived from renewable resources, where the resulting foam has desired performance characteristics, such as appropriate microstructure, polymer composition, and correct density. Ideally, it would be desirable to provide a consumer product including an HIPE foam comprising polymerized monomers derived from renewable resources.

### SUMMARY OF THE INVENTION

In one aspect, the invention relates to a water-in-oil emulsion having a volume to weight ratio of water phase to oil phase in the range of about 8:1 to about 140:1. The oil phase of the emulsion includes about 1% to about 20%, preferably about 4% to about 10%, by weight, of an emulsifier component which is soluble in the oil phase and suitable for forming a stable water-in-oil emulsion, and about 80% to about 99%, by weight, of a monomer component comprising:

(i) about 60% to about 98%, by weight, preferably about 75% to about 95%, by weight of a first substantially water-insoluble monomer selected from the group consisting of a C₂-C₁₈ alkyl acrylate, an aryl acrylate, a C₂-C₁₈ alkyl methacrylate, an aryl methacrylate, and a mixture thereof;

(ii) about 2% to about 40%, preferably about 10% to about 30%, by weight, of a substantially water-insoluble polyfunctional crosslinker selected from the group consisting of an acrylate polyester, a methacrylate polyester, an acrylate methacrylate polyester, and a mixture thereof;

(iii) 0% to about 15%, by weight, of a second substantially water-insoluble monomer (e.g., vinyl chloride, vinylidene chloride, styrene, divinyl benzene, ethyl styrene, chlorostyrene, and mixtures thereof); and,

(iv) optionally a thermal initiator or a photoinitiator.

At least one, and preferably all, of the first substantially water-insoluble monomer (i), polyfunctional crosslinker (ii), and second substantially water-insoluble monomer (iii) exhibit a ¹⁴C/C ratio of about 1.0×10⁻¹³ or greater, preferably about 1.0×10⁻¹² or greater.

In some embodiments, the emulsion has at least about 50, in certain other embodiments at least about 70, and in still other embodiments at least about 80, for example, at least about 95 percent modem carbon (pMC; C¹⁴/C¹²×100%).

The water phase comprises about 0.2% to about 40%, by weight, of a water-soluble electrolyte (e.g., an inorganic water soluble salt). In some embodiments, the water phase optionally includes a polymerization initiator, and further optionally includes a potentiator for the initiator, such as a hydrosulfite.

In another aspect, the invention relates to a process for the preparation of a polymeric foam material from the previously described water-in-oil emulsion. In this aspect, the monomer component of the emulsion is cured in the oil phase of the water-in-oil emulsion at a curing temperature of about 20° C. to about 130° C., preferably about 70° C. to about 110° C., for a time sufficient to form a polymeric foam material (e.g., less than about 5 minutes). In some embodiments, a second water phase containing an initiator and an initiator potentiator, such as a hydrosulfite, is injected immediately after formation of the polymeric foam material. In some embodiments, curing is initiated by heat, ultraviolet radiation, or a mixture thereof.

In some embodiments, the process further comprises dewatering the polymeric foam material to form a collapsed, polymeric foam material that can re-expand upon contact with aqueous fluids. In this embodiment, the volume to weight ratio of water phase to oil phase is in the range of about 12:1 to about 65:1, preferably about 18:1 to about 45:1.

In another aspect, the invention relates to an article comprising a polymer derived from:

(a) a monomer selected from the group consisting of a C₂-C₁₈ alkyl acrylate, an aryl acrylate, a C₂-C₁₈ alkyl methacrylate, an aryl methacrylate, and a mixture thereof, and

(b) a polyfunctional crosslinker selected from the group consisting of acrylate polyester, methacrylate polyester, acrylate methacrylate polyester, and a mixture thereof,

wherein at least one, and preferably each, of the monomer and polyfunctional crosslinker exhibit a ¹⁴C/C ratio of about 1.0×10⁻¹³ or greater, preferably about 1.0×10⁻¹² or greater. In some embodiments, the polymer of the article has at least about 50, preferably at least about 70, more preferably at least about 80, for example, at least about 95 pMC. In some embodiments, the article is a polymeric foam material, such as an open-celled foam prepared from high internal phase emulsions (“HIPE foam”). The HIPE foam is useful as an absorbent core in an absorbent article.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawing. The drawings are not necessarily drawn to scale.

FIG. 1 is a schematic diagram from U.S. Pat. No. 6,365,642 of a continuous process of preparing HIPE foams.

FIG. 2 is a schematic side view from U.S. patent application Ser. No. 12/795,010, depicting an embodiment of the invention.

FIG. 3 is a schematic side view from U.S. patent application Ser. No. 12/795,010, depicting an embodiment of the invention.

FIGS. 4A-F are illustrations of several suitable embodiments of icons communicating reduced petrochemical dependence and/or environmental friendliness.

### DETAILED DESCRIPTION OF THE PREFERRED EMBODIMENTS

### Definitions

“Insulator” refers to any material which reduces the transfer of energy from one location to another.

“Absorbent” refers to materials which imbibe and hold or distribute fluids, usually liquids, an example being a sponge.

“Filter” refers to materials through which a fluid, either gas or liquid can pass, while retaining impurities within the material by size exclusion, interception, electrostatic attraction, adsorption, etc.

“Curing” is the process of converting a HIPE to a HIPE foam. Curing involves the polymerization of monomers into polymers, and typically includes crosslinking A cured HIPE foam is one which has the physical properties, e.g., mechanical integrity, to be handled in subsequent processing steps (which may include a post-curing treatment to confer the final properties desired). Generally, curing is effected via the application of heat or light. An indication of the extent of cure is the mechanical strength of the foam, as measured by yield stress using the method described in the Test Methods section below.

“Polymerization” is the part of the curing process whereby the monomers of the oil phase are converted to a relatively high molecular weight polymer.

“Crosslinking” is the part of the curing process whereby monomers having more than one functional group with respect to free radical polymerization are copolymerized into more than one chain of the growing polymer.

A “batch” process for producing HIPE foam generally involves collecting the HIPE in a specific container in which the HIPE is cured. “Batch” would include processes wherein multiple small containers of relatively sophisticated shapes are used to collect the HIPE. Such shaped vessels can provide for “molded” shapes having three-dimensional features.

A “continuous” process for producing HIPE foam generally involves collecting the HIPE on a moving web or within a pipe or tube or manifold which may pass through a heating zone and produce a continuous element of cured HIPE foam of varied shape and cross-section.

The term “alkyl” as used herein refers to straight chained and branched saturated hydrocarbon groups, nonlimiting examples of which include methyl, ethyl, and straight and branched propyl, butyl, pentyl, hexyl, heptyl, and octyl groups containing the indicated number of carbon atoms. The term Cₙ means the alkyl group has “n” carbon atoms. For example, (C₁-C₇)alkyl refers to alkyl groups having a number of carbon atoms encompassing the entire range (i.e., 1 to 7 carbon atoms), as well as all subgroups (e.g., 1-6, 2-7, 1-5, 3-6, 1, 2, 3, 4, 5, 6, and 7 carbon atoms).

The term “aryl” as used herein refers to a monocyclic or polycyclic aromatic group, preferably a monocyclic or bicyclic aromatic group, e.g., phenyl or naphthyl, and mixed groups, such as benzyl. Unless otherwise indicated, an aryl group can be unsubstituted or substituted with one or more, and in particular one to five groups independently selected from, for example, halogen, alkyl, alkenyl, OCF₃, NO₂, CN, NC, OH, alkoxy, amino, CO₂H, CO₂alkyl, aryl, and heteroaryl. Exemplary aryl groups include, but are not limited to, phenyl, naphthyl, benzyl, tetrahydronaphthyl, chlorophenyl, methylphenyl, methoxyphenyl, trifluoromethylphenyl, nitrophenyl, 2,4-methoxychlorophenyl, and the like.

The term “(meth)acrylate” as used herein is inclusive of methacrylate and/or acrylate. The term “methacrylate” as used herein also includes such moieties as “ethacrylate” and higher derivatives.

The term “(meth)acrylic acid” as used herein is inclusive of methacrylic acid and/or acrylic acid. (Meth)acrylic acid, as used herein, is inclusive of derivatives of (meth)acrylic acid, such as esters, anhydrides, and acyl halides.

“Petrochemical” refers to an organic compound derived from petroleum, natural gas, or coal.

“Petroleum” refers to crude oil and its components of paraffinic, cycloparaffinic, and aromatic hydrocarbons. Crude oil may be obtained from tar sands, bitumen fields, and oil shale.

“Percent modern carbon” (pMC) refers to the ratio of ¹⁴C to ¹²C within a sample (¹⁴C/¹²C) times 100%.

“Renewable resource” refers to a natural resource that can be replenished within a 100 year time frame. The resource can be replenished naturally, or via agricultural techniques. Renewable resources include plants, animals, fish, bacteria, fungi, and forestry products. They can be naturally occurring, hybrids, or genetically engineered organisms. Natural resources such as crude oil, coal, and peat, which take longer than 100 years to form, are not considered renewable resources.

“Agricultural product” refers to a renewable resource resulting from the cultivation of land (e.g., a crop) or the husbandry of animals (including fish).

“Monomeric compound” refers to a compound that can be polymerized to yield a polymer.

“Polymer” refers to a macromolecule comprising repeat units where the macromolecule has a molecular weight of at least 1000 Daltons. The polymer can be a homopolymer, copolymer, terpoymer, etc. The polymer can be produced via free radical, condensation, anionic, cationic, Ziegler-Natta, metallocene, or ring-opening mechanisms. The polymer can be linear, branched, and/or crosslinked.

“Communication” refers to a medium or means by which information, teachings, or messages are transmitted.

“Related environmental message” refers to a message that conveys the benefits or advantages of a HIPE foam comprising a polymer formed from monomers that are derived from a renewable resource, or an article comprising said HIPE foam. Such benefits include being more environmentally friendly, having reduced petroleum dependence, being derived from renewable resources, and the like.

All percentages herein are by weight unless specified otherwise.

HIPEs Comprising Monomers and Crosslinkers Derived from Renewable Resources

In one aspect, the invention relates to emulsions comprising (meth)acrylate monomers and polyfunctional crosslinkers derived from renewable resources. In some embodiments, the (meth)acrylate monomers in the emulsions include a C₂-C₁₈ alkyl (meth)acrylate, preferably a C₄-C₁₆ alkyl (meth)acrylate, more preferably a C₈-C₁₂ alkyl (meth)acrylate, an aryl (meth)acrylate, or a mixture thereof. The alkyl chain of the (meth)acrylate monomers can be straight or branched, and saturated or unsaturated. In some embodiments, the polyfunctional crosslinker in the emulsions comprises a polyfunctional acrylate, a polyfunctional methacrylate, an acrylate methacrylate, or a mixture thereof. In some embodiments, at least about 90%, and preferably about 100%, of the monomers and polyfunctional crosslinkers in the emulsion are derived from renewable materials. In certain embodiments, the emulsion has at least about 50, in certain other embodiments at least about 70, and in still other embodiments about at least about 80, for example, at least about 95 percent modern carbon (pMC; C¹⁴/C¹²×100%).

The monomers of the emulsion of the invention are formed by reacting one equivalent of (meth)acrylic acid or a derivative thereof, such as an ester, anhydride, or acyl halide, with one equivalent of a monofunctional or polyfunctional alcohol, to result in an alkyl acrylate, an aryl acrylate, an alkyl methacrylate, an aryl methacrylate, or a mixture thereof. The polyfunctional crosslinkers of the invention are formed by reacting two equivalents of (meth)acrylic acid with one equivalent of a polyfunctional alcohol, to result in acrylate polyester, methacrylate polyester, acrylate methacrylate polyester, or a mixture thereof. At least one of the (meth)acrylic acid or alcohol is derived from a renewable resource. Preferably, both the (meth)acrylic acid and alcohol are derived from a renewable resource to form monomers and polyfunctional crosslinkers that are derived entirely from renewable resources.

A. Monomers and Crosslinkers Derived from Renewable Resources

The alcohols and acids used to form the monomers and polyfunctional crosslinkers of the invention can be produced from sugars, which are derived from renewable resources. For example, sugars can be fermented to form alcohols and acids, as described in U.S. Patent Application Publication No. 2005/0272134, incorporated herein by reference. Suitable sugars include monosaccharides, disaccharides, trisaccharides, and oligosaccharides. Sugars, such as sucrose, glucose, fructose, and maltose, are readily produced from renewable resources, such as sugar cane and sugar beets. Sugars also can be derived (e.g., via enzymatic cleavage) from other agricultural products, such as starch or cellulose. For example, glucose can be prepared on a commercial scale by enzymatic hydrolysis of corn starch. Other common agricultural crops that can be used as the base starch for conversion into glucose include wheat, buckwheat, arracaha, potato, barley, kudzu, cassava, sorghum, sweet potato, yam, arrowroot, sago, and other like starchy fruit, seeds, or tubers. The sugars produced by these renewable resources (e.g., corn starch from corn) can be used to produce alcohols, such as ethanol and methanol. For example, corn starch can be enzymatically hydrolyzed to yield glucose and/or other sugars. The resultant sugars can be converted into ethanol by fermentation.

The monofunctional alcohols, such as methanol or ethanol, polyfunctional alcohols, such as glycerol, and acids used to form the monomers of the invention can also be produced from fatty acids, fats (e.g., animal fat), and oils (e.g., terpenes, monoglycerides, diglycerides, triglycerides, and mixtures thereof). These fatty acids, fats, and oils can be derived from renewable resources, such as animals or plants. “Fatty acid” refers to a straight chain monocarboxylic acid having a chain length of 12 to 30 carbon atoms. “Monoglycerides,” “diglycerides,” and “triglycerides” refer to mono-, di- and tri-esters, respectively, of (i) glycerol and (ii) the same or mixed fatty acids. Nonlimiting examples of fatty acids include oleic acid, myristoleic acid, palmitoleic acid, sapienic acid, linoleic acid, linolenic acid, arachidonic acid, eicosapentaenoic acid, and docosahexaenoic acid. Nonlimiting examples of monoglycerides include monoglycerides of any of the fatty acids described herein. Nonlimiting examples of diglycerides include diglycerides of any of the fatty acids described herein. Nonlimiting examples of the triglycerides include triglycerides of any of the fatty acids described herein, such as, for example, tall oil, corn oil, soybean oil, sunflower oil, safflower oil, linseed oil, perilla oil, cotton seed oil, tung oil, peanut oil, oiticica oil, hempseed oil, marine oil (e.g., alkali-refined fish oil), dehydrated castor oil, and mixtures thereof. Alcohols can be produced from fatty acids through reduction of the fatty acids by any method known in the art. Alcohols can be produced from fats and oils by first hydrolyzing the fats and oils to produce glycerol and fatty acids, and then subsequently reducing the fatty acids.

Biomass is another renewable resource used to produce the monomers of the invention. “Biomass” is carbon-based biological material derived from living or recently living organisms (e.g., wood, plant matter, waste, hydrogen gas, and alcohols fuels). Methanol, for example, can be produced from the fermentation of biomass. Polyhydroxyalkanoates (PHA) can also be derived from biomass, such as plant biomass and/or microbial biomass (e.g., bacterial biomass, yeast biomass, fungal biomass) to result in, for example, acids and diols, as described in International Patent Application Publication No. WO 2003/051815, incorporated herein by reference.

Specific routes for deriving the (meth)acrylic acid and alcohol components of the emulsion of the invention from renewable resources are described below.

1. (Meth)Acrylic Acid

a. Acrylic Acid

Acrylic acid and its esters and salts can be derived from renewable resources via a number of suitable routes. In one route, glucose derived from a renewable resource (e.g., via enzymatic hydrolysis of corn starch obtained from the renewable resource of corn) can be converted into acrylic acid by a multistep reaction pathway. In this pathway, glucose can be fermented to yield ethanol, which can be dehydrated to yield ethylene. The ethylene subsequently can be converted into propionaldehyde by hydroformylation using carbon monoxide and hydrogen in the presence of a catalyst, such as cobalt octacarbonyl or a rhodium complex. Hydrogenation of the propionaldehyde in the presence of a catalyst, such as sodium borohydride and lithium aluminum hydride, yields propan-1-ol, which can be dehydrated in an acid catalyzed reaction to yield propylene. The propylene can be converted into acrolein by catalytic vapor phase oxidation. Acrolein then can be catalytically oxidized to form acrylic acid in the presence of a molybdenum-vanadium catalyst.

In another route, glucose derived from a renewable resource (e.g., via enzymatic hydrolysis of corn starch) can be converted into acrylic acid via a two step process with lactic acid as an intermediate product. In the first step, glucose can be biofermented to yield lactic acid. Any suitable microorganism capable of fermenting glucose to yield lactic acid can be used including members from the genus Lactobacillus, such as Lactobacillus lactis, as well as those identified in U.S. Pat. Nos. 5,464,760 and 5,252,473, incorporated herein by reference. In the second step, the lactic acid can be dehydrated to produce acrylic acid by use of an acidic dehydration catalyst, such as an inert metal oxide carrier which has been impregnated with a phosphate salt. This acidic dehydration catalyzed method is described in U.S. Pat. No. 4,729,978, incorporated herein by reference. In an alternate suitable second step, the lactic acid can be converted to acrylic acid by reaction with a catalyst comprising solid aluminum phosphate. This catalyzed dehydration method is described in U.S. Pat. No. 4,786,756, incorporated herein by reference.

In another route, glycerol derived from a renewable resource (e.g., via hydrolysis of soybean oil and other triglyceride oils) can be converted into acrylic acid according to a two-step process. In a first step, the glycerol can be dehydrated to yield acrolein. A particularly suitable conversion process involves subjecting glycerol in a gaseous state to an acidic solid catalyst, such as H₃PO₄ on an aluminum oxide carrier (often referred to as solid phosphoric acid), to yield acrolein. Specifics relating to dehydration of glycerol to yield acrolein are disclosed, for example, in U.S. Pat. Nos. 2,042,224 and 5,387,720, incorporated herein by reference. In a second step, the acrolein is oxidized to form acrylic acid. A particularly suitable process involves a gas phase interaction of acrolein and oxygen in the presence of a metal oxide catalyst. A molybdenum and vanadium oxide catalyst can be used. Specifics relating to oxidation of acrolein to yield acrylic acid are disclosed, for example, in U.S. Pat. No. 4,092,354, incorporated herein by reference.

In another route, glucose is converted into acrylic acid using a two step process with 3-hydroxypropionic acid as an intermediate compound. In the first step, glucose can be biofermented to yield 3-hydroxypropionic acid. Microorganisms capable of fermenting glucose to yield 3-hydroxypropionic acid have been genetically engineered to express the requisite enzymes for the conversion. For example, a recombinant microorganism expressing the dhaB gene from Klebsiella pneumoniae and the gene for an aldehyde dehydrogenase has been shown to be capable of converting glucose to 3-hydroxypropionic acid. Specifics regarding the production of the recombinant organism can be found in U.S. Pat. No. 6,852,517, incorporated herein by reference. In the second step, the 3-hydroxypropionic acid can be dehydrated to produce acrylic acid.

Any other route known in the art for the formation of acrylic acid from a renewable resource can be used in this invention. For example, International Patent Application Publication No. WO 2010/031919, incorporated herein by reference, describes the production of polymer grade acrylic acid from bio-resources, such as glycerol. International Patent Application Publication No. WO 2009/028371, incorporated herein by reference, describes the production of acrylic acid from a glycerin mixture comprising a fatty acid and/or a salt of a fatty acid, glyceride, a fatty acid ester, and the like, using little consumption of energy. U.S. Patent Application Publication Nos. 2010/0168472 and 2009/0239995, each incorporated herein by reference, describe the production of acrolein by the liquid phase dehydration of glycerol. The acrolein subsequently can be converted to acrylic acid by methods known to those skilled in the art, as described herein.

b. Methacrylic Acid

Methacrylic acid and its esters and salts can be derived from renewable resources via a number of suitable routes. For example, 2-hydroxyisobutyric acid or 2-hydroxyisobutyramide derived from renewable resources can be dehydrated to form methacrylic acid, as described in Biotechnology Journal 1:756-769 (2006) and Microbiological Biotechnology 66:131-142 (2004). Biosynthetic routes to 2-hydroxyisobutyric acid or bio-2-hydroxyisobutyramide are described in Rohwerder and Mueller, Microbial Cell Factories 9:13 (2010).

In one route, valine is converted to 2-methylpropanal oxime, which is converted to isobutyronitrile using dehydratase and monooxygenase enzymes. The isobutyronitrile is converted to acetone cyanohydrin, which then is hydrolyzed to 2-hydroxyisobutyramide. In this route the nitrile is not derived from renewable resource. The 2-hydroxyisoamide can be converted to 2-hydroxyisobutryic acid using an amidase.

In another route, 2-hydroxyisobutryic acid is derived from the bacterial degradation pathway of methyl tert-butyl ether (MTBE). In this route MTBE is converted to tert-butoxy methanol using a monooxygenase enzyme. The tert-butoxy methanol can spontaneously dismutate to tert-butanol and formaldehyde, or it can be further oxidized to tert-butyl formate using a dehydrogenase enzyme, which undergoes hydrolysis to form the tert-butanol. The tert-butanol is hydroxylated using a none-heme alkane monooxygenase from Mycobacterium austroafricanum IFT 2012 to form 2-methyl-1,2-propanediol. The diol is further oxidized by the dehydrogenases, MpdB and MpdC to form 2-hydroxyisobutyraldehyde and then the carboxylic acid product.

In yet another route, two equivalents of acetyl-CoA are converted to 3-hydroxybutyryl-CoA using known pathways (e.g., through acetoacetyl-CoA using a beta-ketothiolase (PhbA) and a reductase (PhbB)). The 3-hydroxybutyryl-CoA is subjected to CoA-carbonyl mutase (MdpOR) to form 2-hydroxyisobutyryl-CoA, which is subsequently converted to 2-hydroxyisobutyric acid using a hydrolase/transferase.

2. Alcohols

Monofunctional alcohols, such as methanol; ethanol; isomers of propanol, butanol, pentanol, and hexanol; cyclopentanol; isobornyl alcohol; and higher alcohols; and polyfunctional alcohols, such as ethylene glycol, isomers of propanediol, and glycerol, can be derived from renewable resources via a number of suitable routes (see, e.g., WO 2009/155086 and U.S. Pat. No. 4,536,584, each incorporated herein by reference).

In one route, a renewable resource, such as corn starch, can be enzymatically hydrolyzed to yield glucose and/or other sugars. The resultant sugars can be converted into alcohols by fermentation. In another route, fats and oils from plants or animals can be hydrolyzed to yield glycerol and fatty acids. The fatty acids subsequently can be reduced to yield fatty alcohols.

In another route, genetically engineered cells and microorganisms are provided that produce products from the fatty acid biosynthetic pathway (i.e., fatty acid derivatives), such as fatty alcohols, as described in International Patent Application Publication No. WO 2008/119082, incorporated herein by reference. For example, a gene encoding a fatty alcohol biosynthetic polypeptide that can be used to produce fatty alcohols (i.e., C₅-C₂₀ straight or branched alcohols), or a fatty aldehyde biosynthetic polypeptide that can be used to produce fatty aldehydes, which subsequently can be converted to fatty alcohols, is expressed in a host cell. The resulting fatty alcohol or fatty aldehyde then is isolated from the host cell. Such methods are described in U.S. Patent Application Publication Nos. 2010/0105963 and 2010/0105955, and International Patent Application Publication Nos. WO 2010/062480 and WO 2010/042664, each incorporated herein by reference.

In another route, fatty acyl chains are produced from renewable biocrude or hydrocarbon feedstocks using recombinant microorganisms, wherein at least one hydrocarbon is produced by the recombinant microorganism. The fatty acyl chains subsequently can be converted to fatty alcohols using methods known in the art. The microorganisms can be engineered to produce specific degrees of branching, saturation, and length, as described in U.S. Patent Application Publication No. 2010/017826, incorporated herein by reference.

In yet another route, alcohols can be produced from terpenes by reduction and hydration using any method known to one skilled in the art.

3. Mono- or Poly(Meth)Acrylates

The (meth)acrylate monomers and polyfunctional crosslinkers of the emulsion of the invention are formed by reacting (meth)acrylic acid with one or more alcohols using an ester condensation reaction, as previously described herein. This ester condensation reaction can be achieved by any route known in the art. See, for example, U.S. Patent Application Publication No. 2009/0124825, incorporated herein by reference, which describes an improved purification of (meth)acrylate from an aqueous solution using distillation. At least one, and preferably both, of the (meth)acrylic acid and alcohol is derived from a renewable resource.

Aforementioned International Patent Application Publication No. WO 2009/155086 describes the production of renewable (meth)acrylate monomers via esterification of (meth)acrylic acid with an excess of alcohol, each derived from a renewable resource. Examples of these (meth)acrylate monomers derived from renewable sources are listed in the below table.

| Renewable Alcohol | Renewable Acrylate | Renewable Methacrylate |
|---|---|---|
| Methanol | Methyl acrylate | Methyl methacrylate |
| Ethanol | Ethyl acrylate | Ethyl methacrylate |
| 1-Propanol | Propyl acrylate | Propyl methacrylate |
| 2-Propanol | Isopropyl acrylate | Isopropyl methacrylate |
| 1-Butanol | Butyl acrylate | Butyl methacrylate |
| 2-Butanol | Isobutyl acryalte | Isobutyl methacryalte |
| Ethylene Glycol | 2-Hydroxyethyl | 2-Hydroxyethyl |
| | acrylate | methacrylate |
| 1,2-Propylene | 2-Hydroxypropyl | 2-Hydroxypropyl |
| Glycol | acrylate | methacrylate |
| 1,3-Propylene | 3-Hydroxypropyl | 3-Hydroxypropyl |
| Glycol | acrylate | methacrylate |
| 1,4-Butanediol | 4-Hydroxybutyl | 4-Hydroxybutyl |
| | acrylate | methacrylate |
| 1,2-Butanediol | 2-Hydroxybutyl | 2-Hydroxybutyl |
| | acrylate | methacrylate |
| Isobornyl Alcohol | Isobornyl acrylate | Isobornyl methacrylate |

Methacrylate monomers can also be produced from isobutene that is derived from a renewable resource (e.g., from methanol derived from glycerin), as described in Okkerse et al., “From Fossil to Green,” Green Chemistry, April 1999, pp 107-114, i.e., “the Okkerse article,” incorporated herein by reference. The isobutylene can be converted to methacrylamide using ammonia, and thus to methacrylic acid.

Renewable 2-octyl (meth)acrylate can be prepared by conventional techniques from 2-octanol and (meth)acryloyl derivatives, such as esters, acids, and acyl halides. The 2-octanol can be prepared by treatment of ricinoleic acid, derived from castor oil (or an ester or acyl halide thereof), with sodium hydroxide, followed by distillation from the co-product sebacic acid, as described in U.S. Patent Application Publication No. 2010/0151241, incorporated herein by reference.

For example, renewable n-octyl (meth)acrylate can be synthesized by reaction of n-octanol derived from a renewable resource with (meth)acrylic acid derived from a renewable resource. The n-octanol, for example, can be synthesized from caprylic acid by methods previously described, or from n-octene made from renewable ethylene.

Renewable n-decyl (meth)acrylate can be synthesized by reaction of n-decanol from a renewable resource with (meth)acrylic acid derived from a renewable resource. The n-decanol, for example, can be synthesized from capric acid by methods previously described, or from n-decene made from renewable ethylene. Alternatively, the decanol can be derived by reducing and hydrating a terpene that has ten carbon atoms.

Renewable n-dodecyl (meth)acrylate can be synthesized by reaction of n-dodecanol derived from a renewable resource with (meth)acrylic acid derived from a renewable resource. The n-dodecanol, for example, can be synthesized from lauric acid by methods previously described, or from n-dodecylene made from renewable ethylene.

Renewable ethylene glycol dimethacrylate (EGDMA) can be synthesized by reaction of ethylene glycol derived from a renewable resource with (meth)acrylic acid derived from a renewable resource. The ethylene glycol, for example, can be synthesized from ethylene derived from a renewable resource, as previously described, which has been oxidized to from ethylene oxide and then ring opened using water.

Renewable glycerol trimethacrylate can be synthesized by reaction of glycerol derived from a renewable resource, as previously described herein, with (meth)acrylic acid derived from a renewable resource, also as previously described herein.

4. Non-(Meth)Acrylate Monomers

The emulsion of the invention can also comprise non-(meth)acrylate monomers derived from renewable resources. For example, styrene can be produced from phenylalanine by deamination using phenylalanine ammonia lyase, which results in the formation of cinnamic acid. The formed cinnamic acid then can be decarboxylated using a variety of methods, including bio-synthetic pathways. See, e.g., WO 2009/155086 and The Chemical and Pharmaceuticals Bulletin, 49(5):639-641 (2001), each incorporated herein by reference. As another example, biomass can be converted to ethanol, as previously described. The ethanol can then be converted to butadiene, either directly or through ethylene. Two molecules of butadiene then undergo a Diels-Alder cycloaddition using a Cu(I) zeolite catalyst to form vinylcyclohexene. The vinylcyclohexene is dehydrogenated to form styrene, as described in Okkerse article. Alternatively, the biomass can be converted to butadiene through butanol instead of ethanol, and then to styrene using the route previously described.

5. Validation of Polymers Derived from Renewable Resources

A suitable method to validate polymers derived from renewable resources is through ¹⁴C analysis, as described in International Application Publication No. WO 2007/109128. A common analysis technique in carbon-14 dating is measuring the ratio of ¹⁴C to total carbon within a sample (¹⁴C/C). Research has noted that fossil fuels and petrochemicals generally have a ¹⁴C/C ratio of less than about 1×10⁻¹⁵. However, monomers derived entirely from renewable resources typically have a ¹⁴C/C ratio of about 1.2×10⁻¹². Another common analysis technique in carbon-14 dating is measuring the ratio of ¹⁴C to ¹²C within a sample (¹⁴C/¹²C) and multiplying the resulting value by 100% to determine the “percent modern carbon” (pMC).

Carbon-14 is present in biomass as a result of carbon dioxide that is formed when nitrogen is struck by an ultraviolet light produced neutron, causing the nitrogen to lose a proton and form carbon of molecular weight 14, which is immediately oxidized to carbon dioxide. Atmospheric carbon dioxide is cycled by green plants to make organic molecules during photosynthesis. The cycle is completed when green plants or other forms of life metabolize the organic molecules producing carbon dioxide, which is released back to the atmosphere. Virtually all forms of life on Earth depend on this green plant production of organic molecule to produce the chemical energy that facilitates growth and reproduction. Therefore, the carbon-14 that exists in the atmosphere becomes part of all life forms and their biological products. These renewably based organic molecules that biodegrade to carbon dioxide do not contribute to global warming as there is no net increase of carbon emitted to the atmosphere (see WO 2009/155086, incorporated herein by reference).

Petroleum-based carbon does not have the signature radiocarbon ratio of atmospheric carbon dioxide. When compared, the monomers derived from renewable resources may have a ¹⁴C/C ratio three orders of magnitude (10³=1,000) greater than the ¹⁴C/C ratio of monomers derived from petrochemicals. Monomers useful in the present invention have a ¹⁴C/C ratio of about 1.0×10⁻¹⁴ or greater. In other embodiments, the petrochemical equivalent polymers of the present invention may have a ¹⁴C/C ratio of about 1.0×10⁻¹³ or greater, or a ¹⁴C/C ratio of about 1.0×10⁻¹² or greater. Research also has noted that fossil fuels and petrochemicals have less than about 1 percent modern carbon (pMC), and typically less than about 0.1 pMC, for example, less than about 0.03 pMC. However, compounds derived entirely from renewable resources have at least about 95 percent modern carbon (pMC), preferably at least about 99 pMC, for example, about 100 pMC.

Suitable techniques for ¹⁴C analysis are known in the art and include accelerator mass spectrometry, liquid scintillation counting, and isotope mass spectrometry. ASTM International has established a standard method for assessing the bio-based content of materials (ASTM-D6866). These techniques are described in U.S. Pat. Nos. 3,885,155, 4,427,884, 4,973,841, 5,438,194, 5,661,299, and WO 2009/155086, each incorporated herein by reference.

B. HIPE Composition

A High Internal Phase Emulsion (HIPE) comprises two phases, (a) a continuous oil phase comprising a monomer component including monomers and polyfunctional crosslinkers that are polymerized to form a HIPE foam, and an emulsifier component to help stabilize the HIPE, and (b) a water phase.

1. Oil Phase Components

The oil phase of the HIPE comprises (a) a monomer component that includes a first substantially water-insoluble monomer, a polyfunctional crosslinker, and, optionally, a second substantially water insoluble monomer derived from renewable resources, as previously described herein, which are polymerized to form a solid foam structure and, (b) an emulsifier component necessary to stabilize the emulsion. The first monomer is present in the oil phase in an amount of about 60% to about 98%, and preferably about 75% to about 95%, by weight. The polyfunctional crosslinker is present in the oil phase in an amount of about 2% to about 40%, preferably about 10% to about 30%, by weight. The optional second monomer is present in the oil phase in an amount of 0% to about 15%, preferably about 2% to about 8%, by weight. The emulsifier component, which is miscible with the oil phase and suitable for forming a stable water-in-oil emulsion, is present in an amount of about 1% to about 20%, preferably about 4% to about 10%, by weight. The emulsion is formed at an emulsification temperature of about 20° C. to about 130° C., and preferably about 30° C. to about 100° C. The oil phase may also include one or more thermal initiators and/or photoinitiators for polymerization.

a. Monomer Component

In general, the monomer component of the oil phase comprises about 60% to about 98%, preferably about 75% to about 95%, by weight, of at least one first substantially water-insoluble (i.e., a water solubility of less than about 5 mg/mL at 20° C.) monomer selected from the group consisting of a monofunctional alkyl acrylate, an aryl acrylate, an alkyl methacrylate, an aryl methacrylate, and a mixture thereof exhibiting a ¹⁴C/C ratio of about 1.0×10⁻¹³ or greater, preferably about 1.0×10⁻¹² or greater. Exemplary monomers of this type include C₂-C₁₈ alkyl (meth)acrylates, preferably C₄-C₁₆ alkyl (meth)acrylates, and aryl (meth)acrylates, more preferably C₈-C₁₂ alkyl (meth)acrylates, and aryl (meth)acrylates. The alkyl (meth)acrylates can include straight or branched alkyl chains, and unsaturated or saturated alkyl chains. Preferred monomers of this type include 2-ethylhexyl acrylate, 2-ethylhexyl methacrylate, n-butyl acrylate, n-butyl methacrylate, n-hexyl acrylate, n-hexyl methacrylate, n-octyl acrylate, n-octyl methacrylate, 2-octyl acrylate, 2-octyl methacrylate, n-nonyl acrylate, n-nonyl methacrylate, n-decyl acrylate, n-decyl methacrylate, isodecyl acrylate, isodecyl methacrylate, n-dodecyl acrylate, n-dodecyl methacrylate, n-tetradecyl acrylate, n-tetradecyl methacrylate, benzyl acrylate, benzyl methacrylate, nonylphenyl acrylate, nonylphenyl methacrylate, phenyl acrylate, phenyl methacrylate, cyclohexyl acrylate, cyclohexyl methacrylate, 6-methylheptyl acrylate, 6-methylheptyl methacrylate, 2-hydroxyethyl acrylate, 2-hydroxyethyl methacrylate, and a mixture thereof. Appropriate blends of these monomers can provide the desired Tg of the resulting HIPE foams. The preferred monomers include n-octyl acrylate, n-octyl methacrylate, 2-octyl acrylate, 2-octyl methacrylate, 2-ethylhexyl acrylate (EHA) and 2-ethylhexyl methacrylate (EHMA).

The monomer component of the oil phase further comprises about 1% to about 40%, preferably about 5 to about 35%, more preferably about 10% to about 30%, by weight, of a substantially water-insoluble (i.e., a water solubility of less than about 5 mg/mL at 20° C.), polyfunctional crosslinker, such as polyfunctional acrylate, polyfunctional methacrylate, or acrylate methacrylate exhibiting a ¹⁴C/C ratio of about 1.0×10⁻¹³ or greater, preferably about 1.0×10⁻¹² or greater. The crosslinker is added to confer strength and resilience to the resulting HIPE foam. Exemplary crosslinkers include monomers containing two or more activated acrylate and/or methacrylate groups. These acrylate and methacrylate groups generally are the result of a condensation reaction of acrylic acid or methacrylic acid with polyfunctional alcohols.

Nonlimiting examples of diacrylate or dimethacrylate crosslinkers include 1,6-hexanediol diacrylate, 1,4-butanediol acrylate, 1,4-butanediol dimethacrylate, trimethylolpropane triacrylate, trimethylolpropane trimethacrylate, 1,12-dodecyldimethacrylate, 1,14-tetradecanediol dimethacrylate, ethylene glycol dimethacrylate, ethylene glycol diacrylate, 2,2-dimethylpropanediol diacrylate, glucose pentaacrylate, sorbitan pentaacrylate, allyl acrylate and mixtures thereof.

Mixed polyfunctional crosslinkers, such as ethylene glycol acrylate methacrylate and neopentyl glycol acrylate methacrylate, also are useful in the oil phase of the emulsion of the invention. Such mixed crosslinkers can be prepared either by esterification with a mixture of methacrylic acid and acrylic acid combined with the corresponding diol or triol, or by first making the acrylate or methacrylate monofunctionality with a free alcohol, which then is esterified with the other acid, either methacrylic acid or acrylic acid, or by any other means. All of the starting materials used to make the acrylate and methacrylate moieties of the invention can be derived from renewable (meth)acrylic acid and/or renewable alcohols. The ratio of methacrylate:acrylate groups in the mixed crosslinker can be varied from 50:50 to any other ratio as needed in the given instant invention.

Nonlimiting examples of mixed crosslinkers include ethylene glycol acrylate methacrylate, 2,2-dimethylpropanediol acrylate methacrylate, hexanediol acrylate methacrylate, and a mixture thereof.

One preferred crosslinker is ethylene glycol dimethacrylate (EGDMA), though this preference is predicated on the properties desired in the resulting HIPE foam.

Other examples of acrylate, methacrylate, or acrylate methacrylate crosslinkers include those derived from sugar alcohols such as glycol, glycerol, erythritol, threitol, arabitol, xylitol, ribitol, mannitol, sorbitol, dulcitol, iditol, isomalt, malititol, lactitol, and polyglycitol (e.g., glycerol trimethacrylate, sorbitol triacrylate), and those derived from inositol.

Such di-, tri-, tetra-, and higher acrylates and methacrylates derived from renewable resources often contain impurities, such as incompletely esterified alcohols that can be detrimental to emulsion formation and stability. It can be useful to at least partially remove these impurities to improve emulsion stability and formation quality of the resulting HIPE foams.

Optionally, the monomer component of the oil phase includes one or more of a second substantially water-insoluble monomer (i.e., water solubility of less than about 5 mg/mL at 20° C.) in a weight percentage of 0% to about 15%, preferably about 2% to about 8%, to modify properties, as desired. In certain cases, “toughening” monomers, which impart toughness to the resulting HIPE, may be desired. These include monomers, such as styrene, vinyl chloride, vinylidene chloride, isoprene, and chloroprene. Without being bound by theory, it is believed that such monomers aid in stabilizing the HIPE during curing to provide a more homogeneous and better formed HIPE foam, which results in better toughness, tensile strength, and abrasion resistance, for example. Monomers also may be added to confer flame retardancy as disclosed in U.S. Pat. No. 6,160,028, incorporated herein by reference. Monomers also may be added to confer color (e.g., vinyl ferrocene), fluorescent properties, radiation resistance, opacity to radiation (e.g., lead tetraacrylate), to disperse charge, to reflect incident infrared light, to absorb radio waves, to form a wettable surface on the HIPE foam struts, or for any other purpose. In some cases, these additional monomers may slow the overall process of conversion of a HIPE to a HIPE foam, the tradeoff being acceptable when the desired property is conferred. Thus, it typically is desired to minimize the amount of such optional monomers to keep the slowing of the rate of conversion to a minimum, or to exclude these optional monomers unless needed. The preferred optional monomers comprise styrene and vinyl chloride. Styrene in particular is useful in providing a HIPE foam with improved tensile toughness, even when used at a modest level of about 1% to about 15% by weight. Higher levels of styrene can be employed as needed though the effect on reaction kinetics gradually becomes limiting.

b. Emulsifier Component

The oil phase further comprises an amount of an emulsifier component sufficient to form and stabilize the HIPE. Such emulsifiers are generally well known to those skilled in the art, and tend to be relatively hydrophobic in character. (See, for example, Williams, J. M., Langmuir 1991, 7, 1370-1377, incorporated herein by reference.) For HIPEs that are polymerized to provide polymeric foams, suitable emulsifiers can include sorbitan monoesters of branched C₁₆-C₂₄ fatty acids, linear unsaturated C₁₆-C₂₂ fatty acids, and linear saturated C₁₂-C₁₄ fatty acids, such as sorbitan monooleate, sorbitan monomyristate, and sorbitan monoesters derived from coconut fatty acids, as described in U.S. Pat. No. 6,345,642.

Exemplary emulsifiers include sorbitan monolaurate (e.g., SPAN® 20, preferably greater than about 40%, more preferably greater than about 50%, most preferably greater than about 70% sorbitan monolaurate), sorbitan monooleate (e.g., SPAN® 80, preferably greater than about 40%, more preferably greater than about 50%, most preferably greater than about 70% sorbitan monooleate), diglycerol monooleate (e.g., preferably greater than about 40%, more preferably greater than about 50%, most preferably greater than about 70% diglycerol monooleate, or “DGMO”), diglycerol monoisostearate (e.g., preferably greater than about 40%, more preferably greater than about 50%, most preferably greater than about 70% diglycerol monoisostearate, or “DGMIS”), and diglycerol monomyristate (e.g., preferably greater than about 40%, more preferably greater than about 50%, most preferably greater than about 70% sorbitan monomyristate, or “DGMM”). These diglycerol monoesters of branched C₁₆-C₂₄ fatty acids, linear unsaturated C₁₆-C₂₂ fatty acids, or linear saturated C₁₂-C₁₄ fatty acids, such as diglycerol monooleate (i.e., diglycerol monoesters of C18:1 fatty acids), diglycerol monomyristate, diglycerol monoisostearate, and diglycerol monoesters of coconut fatty acids; diglycerol monoaliphatic ethers of branched C₁₆-C₂₄ alcohols (e.g., Guerbet alcohols), linear unsaturated C₁₆-C₂₂ alcohols, and linear saturated C₁₂-C₁₄ alcohols (e.g., coconut fatty alcohols), and mixtures of these emulsifiers are particularly useful. See U.S. Pat. No. 5,287,207 (herein incorporated by reference), which describes the composition and preparation suitable polyglycerol ester emulsifiers, and U.S. Pat. No. 5,500,451 (incorporated by reference herein), which describes the composition and preparation suitable polyglycerol ether emulsifiers. These generally can be prepared via the reaction of an alkyl glycidyl ether with a polyol, such as glycerol. Particularly preferred alkyl groups in the glycidyl ether include isostearyl, hexadecyl, oleyl, stearyl, and other C₁₆-C₁₈ moieties, branched and linear. The product formed using isodecyl glycidyl ether is termed “IDE” and that formed using hexadecyl glycidyl ether is termed “HDE.”

Another general class of preferred emulsifiers is described in U.S. Pat. No. 6,207,724, incorporated herein by reference. Such emulsifiers comprise a composition made by reacting a hydrocarbyl substituted succinic acid or anhydride, or a reactive equivalent thereof, with either a polyol (or blend of polyols), a polyamine (or blend of polyamines), an alkanolamine (or blend of alkanolamines), or a blend of two or more polyols, polyamines, and alkanolamines. One effective emulsifier of this class is polyglycerol succinate (PGS), which is formed from an alkyl succinate and glycerol and triglycerol. Many of the above emulsifiers are mixtures of various polyol functionalities, which are not completely described in the nomenclature. Those skilled in the art recognize that “diglycerol,” for example, is not a single compound because not all of the component is formed by “head-to-tail” etherification in the process.

Such emulsifiers and blends thereof typically are added to the oil phase such that they comprise between about 1% and about 20%, preferably about 2% to about 15%, and more preferably about 3% to about 12%, by weight of the oil phase. Emulsifiers that are particularly able to stabilize HIPEs at high temperatures are preferred. Coemulsifiers also can be used to provide additional control of cell size, cell size distribution, and emulsion stability, particularly at higher temperatures (e.g., greater than about 65° C.). Exemplary coemulsifiers include phosphatidyl cholines and phosphatidyl choline-containing compositions, aliphatic betaines, long chain C₁₂-C₂₂ dialiphatic, short chain C₁-C₄ dialiphatic quaternary ammonium salts, long chain C₁₂-C₂₂ dialkoyl(alkenoyl)-2-hydroxyethyl, long chain C₁₂-C₂₂ dialiphatic imidazolinium quaternary ammonium salts, short chain C₁-C₄ dialiphatic, long chain C₁₂-C₂₂ monoaliphatic benzyl quaternary ammonium salts, the long chain C₁₂-C₂₂ dialkoyl(alkenoyl)-2-aminoethyl, short chain C₁-C₄ monoaliphatic, short chain C₁-C₄ monohydroxyaliphatic quaternary ammonium salts. Particularly preferred is ditallow dimethyl ammonium methyl sulfate (DTDMAMS). Such coemulsifiers and additional examples are described in U.S. Pat. No. 5,650,222, incorporated herein by reference. Exemplary emulsifier systems comprise 6% PGS and 1% DTDMAMS, or 5% IDE and 0.5% DTDMAMS. The former is found useful in forming smaller celled HIPEs and the latter tends to stabilize larger celled HIPEs. Higher levels of any of these components may be needed for stabilizing HIPEs with higher water:oil (W:O ratios, e.g., those exceeding about 35:1).

c. Polymerization Initiator

The oil phase also may contain an oil soluble initiator, such as benzoyl peroxide, di-t-butyl peroxide, lauroyl peroxide, azoisobutyronitrile, 2,2′-azobis(2,4-dimethylvaleronitrile), 2,2′-azobisisobutyronitrile, di(n-propyl) peroxydicarbonate, di(sec-butyl) peroxydicarbonate, di(2-ethylhexyl) peroxydicarbonate, 1,1-dimethyl-3-hydroxybutyl peroxyneodecanoate, alpha-cumyl peroxyneodecanoate, alpha-cumyl peroxyneodecanoate, t-amyl peroxyneodecanoate, t-butyl peroxyneodecanoate, t-amyl peroxypivalate, t-butyl peroxypivalate, 2,5-dimethyl 2,5-di(2-ethylhexanoylperoxy)hexane, t-amyl peroxy-2-ethylhexanoate, t-butyl peroxy-2-ethylhexanoate, t-butyl peroxyacetate, t-amyl peroxyacetate, t-butyl perbenzoate, t-amyl perbenzoate, dicumyl peroxide, 2,5-dimethyl-2,5-di-(t-butylperoxy)hexane, di-t-butyl peroxide, di-t-amyl peroxide, cumeme hydroperoxide, t-butyl hydroperoxide, t-amyl hydroperoxide, 1,1-di-(t-butylperoxy)-3,3,5-trimethylcyclohexane, 1,1-di-(t-butylperoxy)cyclohexane, 1,1-di-(t-amylperoxy)cyclohexane, ethyl 3,3-di-(t-butylperoxy)butyrate, ethyl 3,3-di-(t-amylperoxy)butyrate, and other such initiators known to those skilled in the art. It may be preferred that initiator addition to the monomer phase is just after (or near the end of) emulsification to reduce the potential for premature polymerization, which may clog the emulsification system.

Additionally or alternatively, the oil phase my comprise about 0.05% to about 10%, preferably about 2% to about 10%, by weight, of one or more photoinitiators. Lower amounts of photoinitiator allow light to better penetrate the HIPE foam, which can provide for polymerization deeper into the HIPE foam. However, if polymerization is done in an oxygen-containing environment, sufficient photoinitiator should be present to initiate the polymerization and overcome oxygen inhibition. Photoinitiators can respond rapidly and efficiently to a light source with the production of radicals, cations, and other species that are capable of initiating a polymerization reaction. The photoinitiators used in the present invention may absorb UV light at wavelengths of about 200 nanometers (nm) to about 800 nm, in certain embodiments about 200 nm to about 350 nm, and in certain embodiments about 350 nm to about 450 nm.

Suitable types of oil-soluble photoinitiators include benzyl ketals, α-hydroxyalkyl phenones, α-amino alkyl phenones, and acylphospine oxides. Examples of photoinitiators include 2,4,6-[trimethylbenzoyldiphosphine] oxide in combination with 2-hydroxy-2-methyl-1-phenylpropan-1-one (50:50 blend of the two is sold by Ciba Speciality Chemicals, Ludwigshafen, Germany as DAROCUR® 4265); benzyl dimethyl ketal (sold by Ciba Geigy as IRGACURE® 651); α-,α-dimethoxy-α-hydroxy acetophenone (sold by Ciba Speciality Chemicals as DAROCUR® 1173); 2-methyl-1-[4-(methyl thio)phenyl]-2-morpholino-propan-1-one (sold by Ciba Speciality Chemicals as IRGACURE® 907); 1-hydroxycyclohexyl-phenyl ketone (sold by Ciba Speciality Chemicals as IRGACURE® 184); bis(2,4,6-trimethylbenzoyl)-phenylphosphineoxide (sold by Ciba Speciality Chemicals as IRGACURE® 819); diethoxyacetophenone, and 4-(2-hydroxyethoxy)phenyl-(2-hydroxy-2-methylpropyl) ketone (sold by Ciba Speciality Chemicals as IRGACURE® 2959); and Oligo [2-hydroxy-2-methyl-1-[4-(1-methylvinyl)phenyl]propanone] (sold by Lamberti spa, Gallarate, Italy as ESACURE® KIP EM.

2. Water Phase Components

The water phase of the HIPE comprises about 0.2% to about 40% of one or more electrolytes and, optionally, a polymerization initiator and/or a potentiator for the initiator.

a. Electrolytes

The discontinuous water internal phase of the HIPE is generally one or more aqueous solutions containing one or more dissolved components, as described in U.S. Pat. No. 6,365,642. One dissolved component of the water phase can be a water-soluble electrolyte. The water phase contains about 0.2% to about 40%, preferably about 2% to about 20%, by weight, of a water-soluble electrolyte, preferably an inorganic water-soluble salt. The dissolved electrolyte minimizes the tendency of monomers and crosslinkers, that are primarily oil soluble, to equilibrate into the water phase. Preferred electrolytes include chlorides or sulfates of alkaline earth metals, such as calcium or magnesium. Such electrolytes can include a buffering agent for the control of pH during the polymerization, including inorganic counterions, such as phosphate, borate, and carbonate, and mixtures thereof, for example. Small amounts of water soluble monomers also may be employed, examples being acrylic acid and vinyl acetate.

b. Polymerization Initiator

An optional component of the water phase is a water-soluble free-radical polymerization initiator. Suitable water-soluble free-radical initiators are known to the art. The initiator can be present up to about 20 mole percent based on the total moles of polymerizable monomers present in the oil phase. More preferably, the initiator is present in an amount of about 0.001 to about 10 mole percent based on the total moles of polymerizable monomers in the oil phase. Suitable initiators include ammonium persulfate, sodium persulfate, potassium persulfate, 2,2′-azobis(N,N′-dimethyleneisobutyramidine)dihydrochloride, and other known azo initiators of this type. Because the rate of polymerization is fast with these systems, it can be desirable to add the initiator to the formed or partially formed emulsion, rather than as part of the starting water phase, in order to reduce the amount of premature polymerization that takes place in the emulsification system.

The water phase can optionally include a photoinitiator. Photoinitiators present in the water phase may be at least partially water soluble and may comprise about 0.05% and about 10%, preferably about 0.2% and about 10% by weight of the oil phase. Lower amounts of photoinitiator allow light to better penetrate the HIPE foam, which can provide for polymerization deeper into the HIPE foam, as previously described. Suitable types of water-soluble photoinitiators include benzophenones, benzils, and thioxanthones. Examples of photoinitiators include 2,2′-azobis[2-(2-imidazolin-2-yl)propane]dihydrochloride; 2,2′-azobis[2-(2-imidazolin-2-yl)propane]disulfate dihydrate; 2,2′-azobis(1-imino-1-pyrrolidino-2-ethylpropane)dihydrochloride; 2,2′-azobis[2-methyl-N-(2-hydroxyethyl)propionamide]; 2,2′-azobis(2-methylpropionamidine)dihydrochloride; 2,2′-dicarboxymethoxydibenzalacetone; 4,4′-dicarboxymethoxydibenzalacetone; 4,4′-dicarboxymethoxydibenzalcyclohexanone; 4-dimethylamino-4′-carboxymethoxydibenzalacetone; and 4,4′-disulphoxymethoxydibenzalacetone. Other suitable photoinitiators are disclosed in U.S. Pat. No. 4,824,765, incorporated herein by reference.

c. Potentiator

Another optional component is a potentiator of the initiator, including salts comprising a sulfite moiety. A preferred example is sodium hydrosulfite (NaHSO₃). Other examples include inorganic salts of reduced transition metals, such as Fe(II) sulfate and the like. Other adjuvants include tetraalkyl ammonium salts, such as tetra-n-butyl ammonium chloride. Such salts may function as Phase Transfer Catalysts (PTCs) (as described in Starks, C. M. and Liotta, C., Phase Transfer Catalysis. Principles and Techniques, Academic Press, New York, 1978) to potentiate the transfer of the inorganic initiating species into the oil/monomer phase for more rapid polymerization. Such potentiating species can be added at a point separate from that of the initiator, either before or after, to aid in limiting premature polymerization.

3. Optional Ingredients

Various optional ingredients also may be included in either the water or oil phase, as described in U.S. Pat. No. 6,365,642. Examples include antioxidants (e.g., hindered phenolics, hindered amine light stabilizers, UV absorbers), plasticizers (e.g., dioctyl phthalate, dinonyl sebacate), flame retardants (e.g., halogenated hydrocarbons, phosphates, borates, inorganic salts, such as antimony trioxide or ammonium phosphate or magnesium hydroxide), dyes and pigments, fluorescers, filler particles (e.g., starch, titanium dioxide, carbon black, or calcium carbonate), fibers, chain transfer agents, odor absorbers, such as activated carbon particulates, dissolved polymers and oliogomers, and such other agents as are commonly added to polymers to perform a desired function. Such additives can be added to confer color, fluorescent properties, radiation resistance, opacity to radiation (e.g., lead compounds), to disperse charge, to reflect incident infrared light, to absorb radio waves, or to form a wettable surface on the HIPE foam struts, for example.

### HIPE Foams

A HIPE foam is produced from the polymerization of the monomers derived from renewable resources comprising the continuous oil phase of a HIPE. In certain embodiments, HIPE foams may include one or more layers, and may be either homogeneous or heterogeneous polymeric open-celled foams. Homogeneity and heterogeneity relate to distinct layers within the same HIPE foam, which are similar for homogeneous HIPE foams and are different for heterogeneous HIPE foams. A heterogeneous HIPE foam may contain at least two distinct layers that differ in their chemical composition, physical properties, or both. For example, layers may differ in one or more of foam density, polymer composition, specific surface area, or pore size (also referred to as cell size). A HIPE foam having separate layers formed from differing HIPEs provides a HIPE foam with a range of desired performance characteristics, such as the ability to absorb incoming fluids more quickly and the ability to exert more capillary pressure.

HIPE foams produced from the present invention are relatively open-celled. This refers to the individual cells or pores of the HIPE foam being in substantially unobstructed communication with adjoining cells. The cells in such substantially open-celled HIPE foam structures have intercellular openings or windows that are sufficiently large to permit ready fluid transfer from one cell to another within the HIPE foam structure. For purpose of the present invention, a HIPE foam is considered “open-celled” when at least about 80% of the cells in the HIPE foam that are at least 1 μm in average diameter size are in fluid communication with at least one adjoining cell.

In certain embodiments, for example, when used in certain absorbent articles, a HIPE foam may be flexible and exhibit an appropriate glass transition temperature (Tg). The Tg represents the midpoint of the transition between the glassy and rubbery states of the polymer. In general, HIPE foams having a higher Tg than the temperature of use can be very strong, but also will be rigid and potentially prone to fracture. Since these discontinuous regions also generally exhibit high strength, they can be prepared at lower densities without compromising the overall strength of the HIPE foam.

HIPE foams intended for applications requiring flexibility should contain at least one continuous region having a Tg as low as possible, as long as the overall HIPE foam has acceptable strength at in-use temperatures. In certain embodiments, the Tg of this region will be less than about 30° C. for foams used at about ambient temperature conditions, in certain other embodiments less than about 20° C. For HIPE foams used in applications wherein the use temperature is higher or lower than ambient, the Tg of the continuous region may be no more than 10° C. greater than the use temperature, in certain embodiments the same as use temperature, and in further embodiments about 10° C. less than use temperature where flexibility is desired. Accordingly, monomers are selected that provide corresponding polymers having lower Tg's.

### A. Preparation of HIPE Foams

Foam preparation typically involves the steps of: 1) forming a HIPE; and 2) curing the HIPE under conditions suitable for forming an open-celled cellular polymeric structure. Foam preparation optionally involves removing the original residual water phase from the polymeric foam structure and, optionally, treating the resulting polymeric foam structure with a hydrophilizing surfactant and/or hydratable salt to deposit any needed hydrophilizing surfactant/hydratable salt, optionally thereafter dewatering the resulting polymeric foam structure.

1. HIPE Formation

The HIPE is formed by combining the water and oil phase components in a ratio between about 8:1 and 140:1. This is termed the “water-to-oil” or W:O ratio and is significant because it is the primary determinant of the density of the resulting dried HIPE foam. Preferably, the ratio is between about 10:1 and about 75:1, more preferably between about 13:1 and about 65:1. An exemplary W:O ratio is about 35:1. The ratio is generally expressed as volume of water phase to weight of organic phase. As discussed above, the oil phase typically contains the requisite monomers, crosslinkers, and emulsifiers, as well as optional components. The water phase typically contains one or more electrolytes and one or more polymerization initiators.

The HIPE can be formed from the combined oil and water phases by subjecting these combined phases to shear agitation in a mixing chamber or zone. Shear agitation is generally applied to the extent and for a time period sufficient to form a stable emulsion having aqueous droplets of the size desired. Such a process can be conducted in either batchwise or continuous fashion, and is generally carried out under conditions suitable for forming an emulsion where the water phase droplets are dispersed to such an extent that the resulting polymeric foam will have the requisite structural characteristics.

Emulsification of the oil and water phase combination can involve the use of a mixing or agitation device, such as an impeller. Alternatively, the mixing can be effected by passing the combined oil and water phases through a series of static mixers at a rate necessary to impart the requisite shear. In such a process, a liquid stream comprising the oil phase is formed. Concurrently, a separate larger liquid stream comprising the water phase is also formed. The two separate streams are provided to a suitable mixing chamber or zone at a suitable emulsification pressure and combined therein, such that the requisite water to oil phase weight ratios previously specified are achieved.

In the mixing chamber or zone, the combined streams generally are subjected to shear agitation provided, for example, by an impeller of suitable configuration and dimensions, or by any other means of imparting shear or turbulent mixing generally known to those skilled in the art. Examples of such alternative means of providing shear include in-line mixers are described in PCT Publication No. WO 01/27165, incorporated herein by reference.

Shear typically is applied to the combined oil/water phase stream at an appropriate rate and extent. Once formed, the stable liquid HIPE then can be withdrawn or pumped from the mixing chamber or zone. Preferred methods for forming HIPEs using a continuous process are described in U.S. Pat. Nos. 5,149,720, 5,827,909, and 6,369,121, each incorporated herein by reference), which describe an improved continuous process having a recirculation loop for the HIPE, and a process for the formation of two or more different kinds of HIPEs in the same vessel, using two or more pairs of oil and water streams that can be independently mixed and then blended as required.

2. Polymerization/Curing of the Oil Phase of the HIPE

The HIPE formed, as described above, can be polymerized/cured in a batch process or in a continuous process, as described in U.S. Pat. No. 6,365,642.

A measure of the extent of cure of the polymer is the strength of the foam, as measured by the yield stress described in the Test Methods section below. Another measure of the extent of cure of the polymer is the extent to which it swells in an aggressive solvent, such as toluene (being crosslinked, the HIPE foam does not dissolve without being chemically altered), also described in the Test Methods section below.

Without being bound by theory, it is believed that curing comprises two simultaneous processes. These processes are the polymerization of the renewable monomer to form polymer backbone chains, and the formation of crosslinks between adjacent polymer backbones. Crosslinking is essential to the formation of HIPE foams, with strength and integrity essential to their further handling and use.

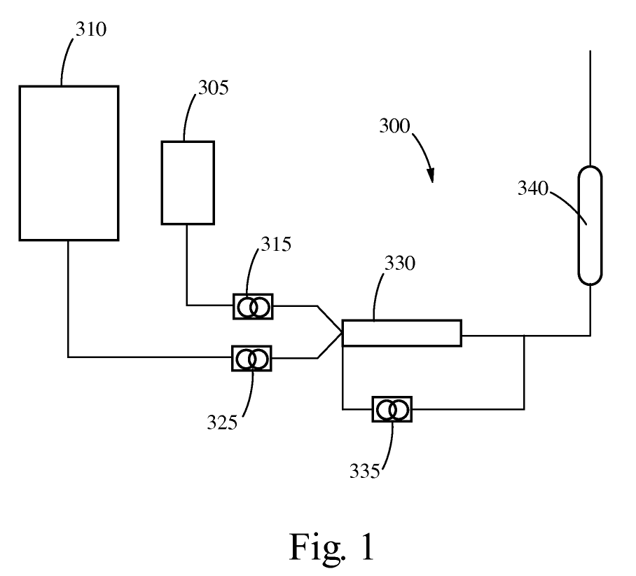

In one embodiment of the present invention, the formed HIPE derived from renewable resources is collected in an individual vessel or molded shape using compatible materials and placed in a suitable curing oven, typically set at temperatures between about 20° C. and about 130° C. The curing temperature is commonly about 80° C. to about 110° C. In a second embodiment, the HIPE derived from renewable resources is formed in a continuous process, as is shown schematically in FIG. 1 (from U.S. Pat. No. 6,365,642). If the vessel is closed and adequately pressure resistant, the curing temperature can be increased beyond 100° C., as needed. Because a higher temperature favors a faster overall curing rate, it will be preferred that the HIPE derived from renewable resources be formed at a higher temperature, e.g., above about 75° C., preferably above about 85° C., and most preferably at about 95° C. The temperature of the suitable curing is most preferably the same as that (or slightly above that) of the forming HIPE derived from renewable resources.

Ultraviolet (UV) light may be used to initiated the polymerization of the monomers of a HIPE. For example, a HIPE may be pre-polymerized using UV light before entering a curing oven, or a HIPE foam could be exposed to UV light upon exiting a curing oven to reduce the level of unreacted monomers, or the UV light could be used in place of a curing oven to polymerize the monomers of a HIPE. There may be one or more sources of UV light used to polymerize the HIPE monomers. The sources may be the same or different. For example, the sources may differ in the wavelength of the UV light they produce or in the amount of time a HIPE is exposed to the UV light source. The UV light wavelength in the range of about 200 to about 400 nm, and in certain embodiments of about 200 nm to 350 nm, overlaps to at least some degree with the UV light absorption band of the photoinitiator and is of sufficient intensity and exposure duration to polymerize monomers in a HIPE. Use of UV light in the formation of HIPE foams is described in U.S. patent application Ser. Nos. 12/794,945, 12/794,952, 12/794,962, 12/794,977, and 12/794,993, each incorporated herein by reference.

3. Optional Removal of Residual Water Phase

Following polymerization, the resulting HIPE foam is saturated with water phase that can be removed to obtain a substantially dry HIPE foam. In certain embodiments, HIPE foams can be squeezed free of most of the water phase by using compression, for example by running the HIPE foam through one or more pairs of nip rollers. The nip rollers can be positioned such that they squeeze the water phase out of the HIPE foam. The nip rollers can be porous and have a vacuum applied from the inside such that they assist in drawing water phase out of the HIPE foam. In certain embodiments, nip rollers can be positioned in pairs, such that a first nip roller is located above a liquid permeable belt, such as a belt having pores or composed of a mesh-like material and a second opposing nip roller facing the first nip roller and located below the liquid permeable belt. One of the pair, for example the first nip roller, can be pressurized while the other, for example the second nip roller, can be evacuated, so as to both blow and draw the water phase out the of the HIPE foam. The nip rollers may also be heated to assist in removing the water phase. In certain embodiments, nip rollers are only applied to non-rigid HIPE foams, that is HIPE foams whose walls would not be destroyed by compressing the HIPE foam. In yet a further embodiment, the surface of the nip rollers may contain irregularities in the form of protuberances, depressions, or both such that a HIPE foam can be embossed as it is moving through the nip rollers. When the HIPE has the desired dryness it may be cut or sliced into a form suitable for the intended application.

In certain embodiments, in place of or in combination with nip rollers, the water phase may be removed by sending the HIPE foam through a drying zone where it is heated, exposed to a vacuum, or a combination of heat and vacuum exposure. Heat can be applied, for example, by running the foam though a forced air oven, IR oven, microwave oven or radiowave oven. The extent to which a HIPE foam is dried depends on the application. In certain embodiments, greater than 50% of the water phase is removed. In certain other embodiments greater than 90%, and in still other embodiments greater than 95% of the water phase is removed during the drying process.

### B. Exemplary Embodiments

### 1. Belt Assembly

FIG. 1 (from U.S. Pat. No. 6,365,642) describes one method and an apparatus 300 suitable for continuously forming HIPE foams. A HIPE derived from renewable resources is made using the methods generally described in the aforementioned U.S. Pat. Nos. 5,149,720, 5,827,909, and 6,365,642. That is, the oil phase (desired blend of monomers from renewable resources and emulsifier) is prepared and stored in an oil phase supply vessel 305. Similarly, the desired water phase (blend of water, electrolyte, and initiator) is prepared and stored in a water phase supply vessel 310. The oil phase and the water phase are supplied in the desired proportions to mixhead 330 by an oil phase supply pump 315 and a water phase supply pump 325. The mixhead 330 supplies the mechanical energy (shear) necessary to form the HIPE derived from renewable resources. If desired, a HIPE recirculation pump 335 can be used.

The formed HIPE derived from renewable resources is pumped into an elongated curing chamber 340 having specific cross-sectional shape and dimensions as desired for the foam product. The oil phase supply pump 315 and the water phase supply pump can be used to pump the HIPE derived from renewable resources from the mixhead 330 to the curing chamber 340. In this case, emulsification will occur at substantially the curing pressure.

In an alternative embodiment, multiple systems similar to those described above can be used to make multiple HIPEs derived from renewable resources having different combinations of properties (e.g., pore dimensions, mechanical properties, etc.). Such multiple HIPEs can be introduced into the curing chamber 340 in order to provide a cured foam having regions of varying properties as desired for a particular end use, as described in U.S. Pat. No. 6,365,642.

The chamber 340 further may be lined with a material compatible with the HIPE derived from renewable resources such that degradation of the HIPE structure at the interior surfaces which contact the HIPE is avoided. The compatible material also is not degraded by the oil or water phase components at the elevated temperatures used. The compatible material may comprise a continuously moving belt on which the curing HIPE derived from renewable resources is supported. Optionally, a slip layer can be provided between the curing HIPE derived from renewable resources and the chamber walls to minimize uneven flow patterns as the HIPE progresses through the chamber 340. As with the lining discussed above, the slip layer must be compatible with the oil and water phase components of the HIPE derived from renewable resources and have sufficient mechanical stability at the curing temperature to be effective.

At least a portion of the chamber 340 is heated in order to bring the HIPE derived from renewable resources to the intended curing temperature (or to maintain the HIPE at its temperature if it was formed at the desired curing temperature) as it passes through this section or zone. Any manner of heating this section or zone can be employed in order to reach and maintain the desired temperature in a controlled fashion. Examples include heating by resistive electrical elements, steam, hot oil or other fluids, hot air or other gases, open flame, or any other method of heating known to those skilled in the art. Optionally, a static mixer/heat exchanger or other forced convection heat exchanger can be utilized in the heated section to improve heat transfer into the HIPE derived from renewable resources. Once the HIPE derived from renewable resources begins to gel, the composition can no longer be mixed because of the risk of damaging or even destroying the structure of the foam.

The length of the optional heated section, the temperature of the optional heated section, and the rate at which the emulsion is pumped through the tube are selected to allow for sufficient residence time within the chamber 340 for adequate heat transfer to the center of the chamber 340 in order to attain complete cure. If the optional heating is done in chamber 340, then chamber 340 with relatively thin cross-sectional dimensions are preferred in order to facilitate rapid heat transfer. The HIPE derived from renewable resources is substantially cured into a HIPE foam by the time it exits the curing chamber 340. Optionally, an elevated extension 350 can be located above and downstream of the curing chamber 340 in order to provide a hydrostatic head.

The curing 340 can have any desired cross-section that is consistent with the flow requirements of pumping the curing HIPE derived from renewable resources. For example, the cross-section can be rectangular, circular, triangular, annular, oval, hourglass, dog bone, asymmetric, etc., as may be desired for a particular use of the cured HIPE. Preferably, the cross-sectional dimensions of the chamber 340 are such that the polymerized HIPE foam is produced in sheet-like form with the desired cross-sectional dimensions. Alternatively, the cross-sectional shape can be designed to facilitate manufacture of the desired product in subsequent processes. For example, an hourglass-shaped cross-section (or conjoined hourglass sections) of the appropriate size may facilitate making disposable absorbent products, such as diapers, by cutting relatively thin slices or sheets of the shaped HIPE foam derived from renewable resources. Other sizes and shapes can be prepared for making feminine hygiene pads, surgical drapes, face masks, and the like. Regardless of the cross-sectional dimensions of the curing chamber 340, the resultant HIPE foam derived from renewable resources can be cut or sliced into a sheet-like form with thickness suitable for the intended application.

The cross-section of the curing chamber 340 can be varied along the length of the chamber in order to increase or decrease the pressure required to pump the HIPE derived from renewable resources through the chamber. For example, the cross-sectional area of a vertical curing chamber can be increased above the point at which the HIPE foam derived from renewable resources is cured, in order to reduce the resistance to flow caused by friction between the walls of the chamber and the cured foam.

A solution of initiator and/or potentiator can optionally be injected into the HIPE at a point between the mixhead 330 and the curing chamber 340. If the optional injection of initiator is chosen, the water phase, as provided from the water phase supply vessel, is substantially initiator free. Additional mixing means, such as a continuous mixer, also may be desirable downstream of the injection point and upstream of the curing chamber 340 to ensure the initiator solution is distributed throughout the HIPE derived from renewable resources. Such an arrangement has the advantage of substantially reducing the risk of undesirable curing in the mixhead 330 in the event of an unanticipated equipment shutdown.

A porous, water-filled, open-celled HIPE foam derived from renewable resources is the product obtained after curing in the reaction chamber. As noted above, the cross-sectional dimensions of the chamber 340 preferably are such that the polymerized HIPE foam derived from renewable resources is produced in sheet-like form with the desired cross-sectional dimensions. Alternative cross-sectional dimensions can be employed, but regardless of the shape of the curing chamber 340, the resultant HIPE foam derived from renewable resources can be cut or sliced into a sheet-like form with thickness suitable for the intended application.

Sheets of cured HIPE foam derived from renewable resources are easier to process during subsequent treating/washing and dewatering steps, as well as to prepare the HIPE foam derived from renewable resources for use in the intended application. Alternatively, the HIPE foam derived from renewable resources can be cut, ground or otherwise comminuted into particles, cubes, rods, spheres, plates, strands, fibers, or other desired shapes. If the HIPE foam derived from renewable resources is to be shaped in this fashion, it often is useful to form it in a very thick section, e.g., up to several feet thick, in a rectilinear shape often termed a “billet,” which increases the process throughput.

The water phase remaining with the HIPE foam derived from renewable resources typically is partially or wholly removed by compressing the foam. Remaining moisture can be removed as desired by conventional evaporative drying techniques or by freeze drying, solvent exchange, or any other method that reduces the water level to the desired amount.

### 2. Retractable Piston Assembly

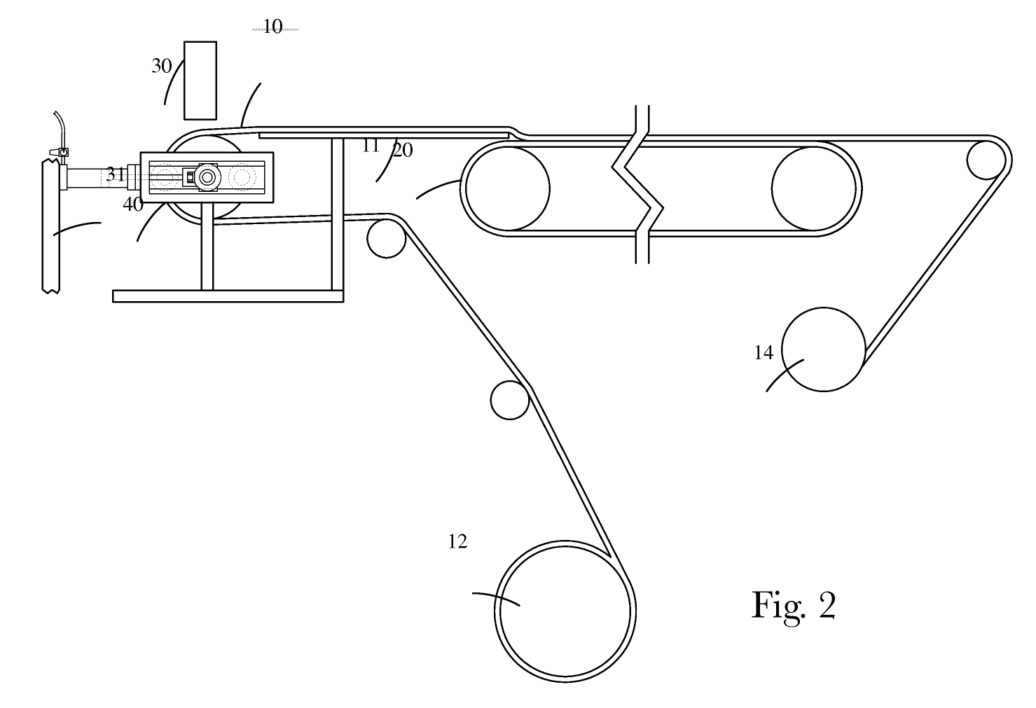

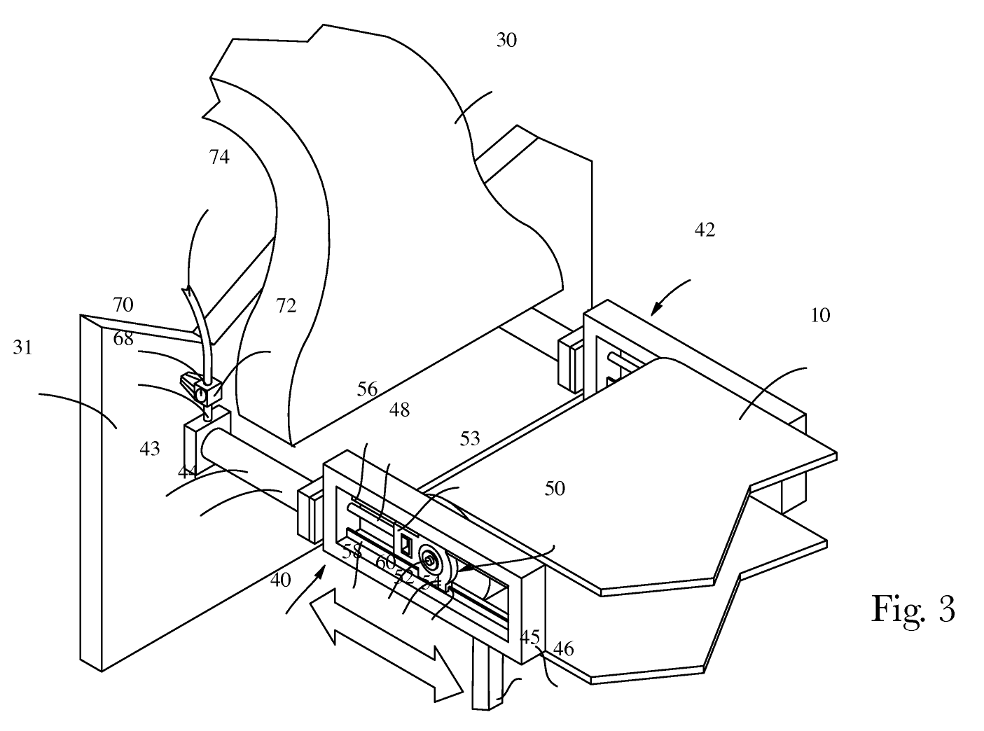

In one embodiment of the present invention, as shown in FIGS. 2 and 3, the extruding device is a die 30 mounted on a die stand 31. The die 30 extrudes a HIPE on to a carrier sheet 10 which is supported by a support plate 11 and the underlying belt 20. One or more retractable piston assemblies 40, which in this embodiment are attached at one end to the die stand 31, move the carrier sheet 10 either under the die 30 or away from the die 30. Retractable piston assemblies may be mounted at any suitable position along the HIPE foam making process. For example, in other embodiments, retractable piston assemblies may be mounted in an orientation opposite that shown in FIG. 2, by mounting a retractable piston assembly to the belt structure, such that the retractable piston assembly is facing the die stand rather than the belt. In addition, while FIG. 3 shows two retractable piston assemblies, more or fewer retractable piston assemblies may be used. A retractable piston assembly allows control as to whether a HIPE is extruded on the carrier sheet. For example, during start-up or at the end of the of the HIPE foam making process, the HIPE that is produced can be in a condition that does not produce usable HIPE foam, however the HIPE will become part of the HIPE foam produced if it is extruded on the carrier sheet. Therefore, during these instances the carrier sheet is moved from under the extruding device, using a retractable piston assembly such that HIPE will not be extruded on the carrier sheet. Further, when the extruding device needs to be cleaned, the waste generated during the cleaning process will not be extruded on the carrier sheet and the extruding device will be easier to access, as the carrier sheet can be moved out of the way using the retractable piston assembly, rather than having to move the extruding device. Advantages to using a retractable piston assembly include easier maintenance of the equipment, improved reproducibility, and gap measurement and control.

The carrier sheet may have a thickness that in certain embodiments in the range of about 0.005 mm to about 0.1 mm. The carrier sheet may comprise one or more materials suitable for the polymerization conditions (various properties such as heat resistance, chemical resistance, weatherability, surface energy, abrasion resistance, recycling property, tensile strength, and other mechanical strengths), and may comprise at least one material from the group including films, non-woven materials, woven materials, and combinations thereof. Examples of films include, fluorine resins, such as polytetrafluoroethylene, tetrafluoroethylene-perfluoroalkylvinyl ether copolymers, tetrafluoroethylene-hexafluoropropylene copolymers, and tetrafluoroethylene-ethylene copolymers; silicone resins, such as dimethyl polysiloxane and dimethylsiloxane-diphenyl siloxane copolymers; heat-resistant resins, such as polyimides, polyphenylene sulfides, polysulfones, polyether sulfones, polyether imides, polyether ether ketones, and para type aramid resins; thermoplastic polyester resins, such as polyethylene terephthalates, polybutylene terephthalates, polyethylene naphthalates, polybutylene naphthalates, and polycyclohexane terephthalates; thermoplastic polyester type elastomer resins, such as block copolymers (polyether type) formed of PBT and polytetramethylene oxide glycol and block copolymers (polyester type) formed of PBT and polycaprolactone may be used. These materials may be used either singly or in mixed form of two or more materials. Further, a carrier sheet may be a laminate comprising two or more different materials or two or more materials of the same composition, but which differ in one or more physical characteristics, such as quality or thickness. Still further, the carrier sheet surface can be treated to modify its properties, such as contact angle, surface energy, chemical resistance, or other useful properties. In certain embodiments, a carrier sheet has substantially the same width as the belt it is disposed on. In other embodiments, a carrier sheet may have a width greater or less than the belt it is disposed on. In certain embodiments the belt or a film positioned on the belt and moving therewith may be transparent to UV light; allowing the UV light from a UV light source positioned below the belt, film or both to polymerize the monomers in a HIPE foam. In other embodiments, the belt may comprise one or more UV reflective materials, as described in U.S. patent application Ser. No. 12/795,004.

Suitable retractable piston assemblies to form the HIPE foams of the invention are described in U.S. patent application Ser. Nos. 12/795,004 and 12/795,010, each incorporated herein by reference. In certain embodiments, the retractable piston assembly of the present invention can be used with a screw-type mechanism, as described in U.S. patent application Ser. Nos. 12/795,004 and 12/795,010.

### C. Test Methods

The test methodologies for measuring Tg, yield stress, expansion factors, and stability in the compressed state are disclosed in U.S. Pat. Nos. 6,365,642 and 5,753,359, incorporated herein by reference.

Swelling Ratio: Swelling ratio can be used as a relative measure of the degree of crosslinking of the polymer derived from renewable resources comprising the HIPE foam. The degree of crosslinking is the critical part of curing, as defined herein above. Swelling ratio is determined by cutting a cylindrical sample of the foam 2-6 mm thick, 2.5 cm in diameter. The foam sample is thoroughly washed with water and 2-propanol to remove any residual salts and/or emulsifier. This is be accomplished by placing the sample on a piece of filter paper in a Buchner funnel attached to a filter flask. A vacuum is applied to the filter flask by means of a laboratory aspirator and the sample is thoroughly washed with distilled water and then with 2-propanol, such that the water and 2-propanol are drawn through the porous foam by the vacuum. The washed foam sample then is dried in an oven at 65° C. for three hours, removed from the oven, and allowed to cool to room temperature prior to measurement of the swelling ratio. The sample is weighed to within ±1 mg, to obtain the dry weight of the sample, Wd.

The sample then is placed in a vacuum flask containing sufficient methanol to completely submerge the foam sample. Remaining air bubbles in the foam structure are removed by gentle reduction of the pressure in the flask by means of a laboratory aspirator. Gentle vacuum is applied and released several times until no more bubbles are observed leaving the foam sample when the vacuum is applied, and the foam sample sinks upon release of the vacuum. The completely saturated foam sample is gently removed from the flask and weighed to within ±1 mg, taking care not to squeeze any of the methanol out of the sample during the weighing process. After the weight of the methanol saturated sample is recorded, (Wm), the sample is again dried by gently expressing most of the methanol followed by oven drying at 65° C. for 1 hour. The dry sample then is placed into a vacuum flask containing sufficient toluene to completely submerge the foam sample. Residual air trapped within the pores of the foam is removed by gentle application and release of vacuum, as described above. The toluene saturated weight of the sample, Wt, is also obtained as described above. The swelling ratio can be calculated from the densities of methanol and toluene, and the weights recorded in the above procedure as follows:

Swelling Ratio=[(Wt−Wd)/(Wm−Wd)]×0.912,
where 0.912 is the ratio of the densities of methanol and toluene.

Yield Stress: Yield stress is the most practical measure of the degree of curing and relates to the compression strength of the HIPE foam derived from renewable resources. Yield stress is the stress at which a marked change in the slope of the stress-strain curve occurs. This is practically determined by the intersection of extrapolated regions of the stress-strain curve above and below the yield point, as described in more detail below. The general test method for measuring yield stress is disclosed in U.S. Pat. Nos. 6,365,642 and 5,753,359. Specifically, for the purposes of this application, the following method is used:

Apparatus: Rheometrics RSA-2 or RSA-3 DMA, as is available from Rheometrics Inc., of Piscataway, N.J.

Setup: 0.1% strain rate per second for 600 seconds (to 60% strain) using 2.5 cm diameter parallel plates in compression mode; 31° C. oven temperature held for 10 minutes prior to the start of the test, and throughout the test.

Sample: HIPE foam samples derived from renewable resources cut into cylinders 2-6 mm thick and 2.5 cm in diameter. Samples are expanded by washing in water as necessary. Water washing to remove any residual salts is the common practice as these can influence the results. Solvent extraction of the residual emulsifier can also be practiced though the results will show stronger foams in general.

The resulting stress-strain curve can be analyzed by line fitting the initial linear elastic and plateau portions of the plot using a linear regression method. The intersection of the two lines thus obtained provides the yield stress (and yield strain).

Density: Foam density can be measured on dry, expanded foams using any reasonable method. The method used herein is disclosed in the aforementioned U.S. Pat. Nos. 6,365,642 and 5,387,207. In certain embodiments a HIPE foam may have an expanded dry density of about 15 mg/cc to about 40 mg/cc.

### Articles Comprised of HIPE Foams Derived from Renewable Resources

In another aspect, the present invention relates to articles that are comprised of HIPE foams derived from renewable resources. The HIPE foams of the invention can be used in thermal, acoustic, electrical, and mechanical (e.g., for cushioning or packaging) applications. Articles comprising the HIPE foams of the invention include insulators, absorbent materials, filters, membranes, floor mats, toys, and carriers for inks, dyes, lubricants, and lotions. For example, the HIPE foam of the invention is useful as an absorbent core material in absorbent articles, such as feminine hygiene articles (e.g., pads, pantiliners, tampons), disposable diapers, incontinence articles (e.g., pads, adult diapers), homecare articles (e.g., wipes, pads, towels), and beauty care articles (e.g., pads, wipes, and skin care articles, such as used for pore cleaning).

As described in U.S. Pat. Nos. 5,849,805, 5,260,345, and 5,268,224, each incorporated herein by reference, a HIPE foam of the invention is useful as absorbent articles for blood and blood-based fluids, such as for catamenial pads, tampons, wound dressings, bandages, and surgical drapes. The cells in the substantially open-celled foam structures of the HIPE foams of the invention provide passageways large enough to permit free and ready movement of blood and blood-based fluids from one cell to another within the foam structure, even though such fluids contain certain insoluble components. However, these cells also are small enough to provide necessary high capillary absorption pressure (i.e., capillary specific surface area per volume) to effectively move fluids throughout the foam. Further advantages of the HIPE foams of the invention in absorbent articles include good wicking capability, high surface area, resistance to compression deflection, and free absorbent capacity, for example.

### Communicating a Related Environmental Message a Consumer

In another aspect, the present invention relates to communicating a related environmental message to a consumer. The related environmental message may convey the benefits or advantages of HIPE foams that comprise a polymer formed from monomers derived from a renewable resource, or articles made from these HIPE foams (e.g., absorbent articles). The related environmental message may identify the HIPE foam as: being environmentally friendly or Earth friendly; having reduced petroleum, oil, or coal dependence or content; having reduced foreign petroleum, oil, or coal dependence or content; having reduced petrochemicals or having components that are petrochemical free; and/or being made from renewable resources or having components made from renewable resources. This communication is of importance to consumers that may have an aversion to petrochemical use (e.g., consumers concerned about depletion of natural resources or consumers who find petrochemical based products unnatural or not environmentally friendly) and to consumers that are environmentally conscious. Without such a communication, the benefit of the present invention maybe lost on some consumers.

The communication may be effected in a variety of communication forms. Suitable communication forms include store displays, posters, billboard, computer programs, brochures, package literature, shelf information, videos, advertisements, internet web sites, pictograms, iconography, or any other suitable form of communication. The information could be available at stores, on television, in a computer-accessible form, in advertisements, or any other appropriate venue. Ideally, multiple communication forms may be employed to disseminate the related environmental message.

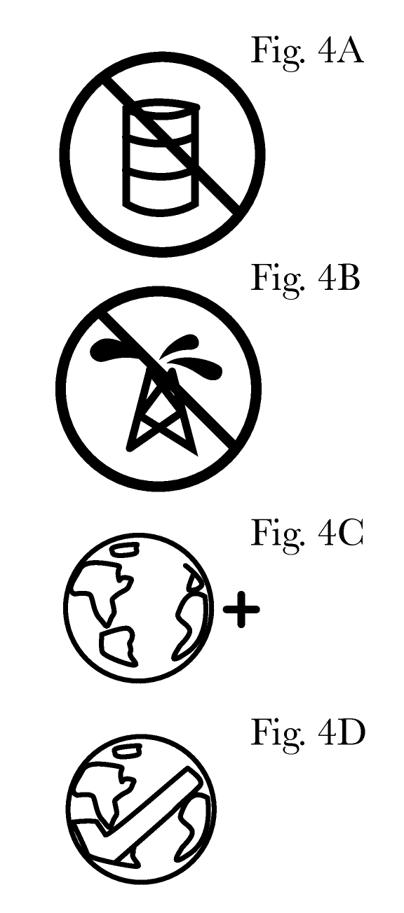

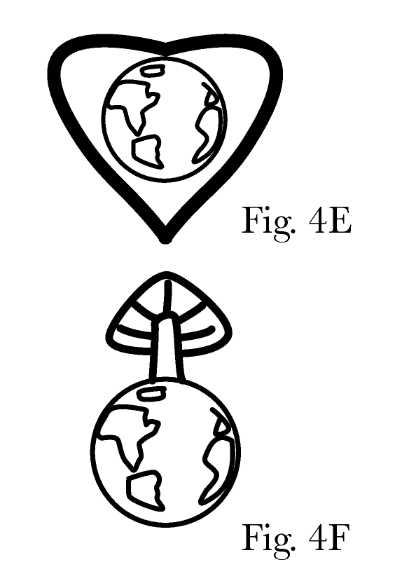

The communication may be written, spoken, or delivered by way of one or more pictures, graphics, or icons. For example, a television or internet based-advertisement may have narration, a voice-over, or other audible conveyance of the related environmental message. Likewise, the related environmental message may be conveyed in a written form using any of the suitable communication forms listed above. In certain embodiments, it may be desirable to quantify the reduction of petrochemical usage of the HIPE foam or article comprising the HIPE foam compared to HIPE foams or articles comprising HIPE foams that are presently commercially available. In other embodiments, the communication form may be one or more icons. FIGS. 4A-F depict several suitable embodiments of a communication in the form of an icon. One or more icons may be used to convey the related environmental message of reduced petrochemical usage. In certain embodiments, the icons may be located on the packaging of the HIPE foam or article comprising the HIPE foam, on the article comprising the HIPE foam, on an insert adjoining the package or the article comprising the HIPE foam, or in combination with any of the other forms of the communication listed above.

The related environmental message also may include a message of petrochemical equivalence. Many renewable, naturally occurring, or non-petroleum derived polymers often lack the performance characteristics that consumers have come to expect when used in HIPE foams or articles comprising HIPE foams (eg., absorbent articles). Therefore, a message of petroleum equivalence may be necessary to educate consumers that the polymers derived from renewable resources, as described above, exhibit equivalent or better performance characteristics as compared to petroleum derived polymers. A suitable petrochemical equivalence message can include comparison to a HIPE foam or article comprising a HIPE foam that does not have a polymer derived from a renewable resource. For example, a suitable combined message may be, “Diaper Brand A with an environmentally friendly absorbent material is just as absorbent as Diaper Brand B.” This message conveys both the related environmental message and the message of petrochemical equivalence.

### Example

### Small Scale Batch Preparation of a HIPE Foam Derived from Renewable Resources

A. Emulsifier Preparation

The emulsifier used to stabilize the HIPE in this example is prepared as follows. Hexadecyl glycidyl ether (HDE, Aldrich of Milwaukee, Wis., 53201, 386 g) and isostearyl glycidyl ether (IDE, RSA Corp. of Danbury, Conn., 06810, 514 g) is melted in a round bottomed flask equipped with an over-head stirrer. The flask is blanketed with dry nitrogen during the melting. To the stirring melt is added a mixture of glycerol (Aldrich, 303 g) and N,N,N′,N′-tetramethyl-1-6-hexanediamine (Aldrich, 22.7 g). The mixture then is heated to 135° C. using an oil bath for 3 hours. The temperature then is reduced to and held at 95° C. overnight. The resulting product is termed IDE/HDE and is used without further purification. If only the isostearyl starting material is employed, then obviously the emulsifier is termed simply “IDE”.

B. HIPE Preparation

The water phase used to form the HIPE is prepared by dissolving anhydrous calcium chloride (30.0 g) and sodium persulfate (0.30 g) in 300 mL of water. The oil phase is prepared by mixing n-octyl acrylate (OA, 7 g), n-octyl methacrylate (OMA, 7 g), purified ethylene glycol dimethacrylate (EGDMA) (6 g), and HDE/IDE emulsifier (1 g). These monomers are derived from renewable resources, as described above. This provides the oil phase to form the HIPE. The monomer percentages by weight are 80% n-octyl (meth)acrylate and 20% EGDMA.

The oil phase (7 g) is weighed into a high-density polyethylene cup with vertical sides and a flat bottom. The internal diameter of the cup is 70 mm and the height of the cup is 120 mm (these dimensions being primarily for convenience). The oil phase is stirred using an overhead stirrer equipped with a stainless steel impeller attached to the bottom of a stainless steel shaft % inch (9.5 mm) in diameter. The impeller has 6 arms extending radially from a central hub, each arm with a square cross section 3.5 mm×3.5 mm, and a length of 27 mm measured from the shaft to the tip of the arm. The oil phase is stirred with the impeller rotating at 250 to 300 rpm, while 210 mL of pre-heated water phase at 80° C. is added drop-wise over a period of about 3 to about 4 minutes to form a high internal phase emulsion. (Essentially any other suitable relatively low shear mixing device or system may be employed.) The impeller is raised and lowered within the emulsion during the addition of the water phase so as to achieve uniform mixing of the components. The ratio of the water phase (210 mL) to the oil phase (7 g) is 30:1 in this experiment (i.e., W:O ratio). The temperature of the HIPE just after formation is 70° C.

C. Polymerization/Curing of HIPE

The cup containing the HIPE is placed in an oven set at 85° C. for a period of about 5 minutes. Upon removal from the oven, the container is immediately submerged in an ice/water bath containing to cool the vessel and its contents rapidly. After several minutes, the vessel is removed from the ice/water bath and the cured foam within is removed carefully for washing, dewatering, and characterization, as described in the Test Methods section above.

D. Foam Washing and Dewatering

The cured HIPE foam is removed from the container. The foam at this point has residual water phase (containing dissolved or suspended emulsifiers, electrolyte, initiator residues, and initiator) about 30 times the weight of polymerized monomers. The foam is dewatered by placing the sample on a piece of filter paper in a Buchner funnel attached to a filter flask. A vacuum is applied to the filter flask by means of a laboratory aspirator and the sample is thoroughly washed with distilled water, then with 2-propanol such that the water and 2-propanol are drawn through the porous foam by the vacuum. The washed foam sample then is dried in an oven at 65° C. for three hours, removed from the oven, and allowed to cool to room temperature prior to characterization as described in the Test Methods section above.

This general process can be repeated using variation in monomer formulation, curing temperatures, initiator/potentiator types, W:O ratios, emulsifier type and level, and the like. Representative data are shown in the below Table.

| Example | % OA | % OMA | % EGDMA | % STY | W:O |
|---|---|---|---|---|---|
| 1 | 0 | 60 | 40 | 0 | 25:1 |
| 2 | 45 | 50 | 5 | 0 | 25:1 |
| 3 | 10 | 50 | 40 | 0 | 25:1 |
| 4 | 20 | 40 | 40 | 0 | 25:1 |
| 5 | 35 | 35 | 30 | 0 | 25:1 |
| 6 | 37.5 | 37.5 | 25 | 0 | 30:1 |
| 7 | 45 | 45 | 10 | 0 | 15:1 |
| 8 | 40 | 40 | 20 | 0 | 25:1 |
| 9 | 60 | 0 | 40 | 0 | 25:1 |
| 10 | 40 | 20 | 40 | 0 | 25:1 |
| 11 | 50 | 10 | 40 | 0 | 25:1 |
| 12 | 50 | 45 | 5 | 0 | 25:1 |
| 13 | 0 | 60 | 35 | 5 | 25:1 |
| 14 | 10 | 50 | 35 | 5 | 25:1 |
| 15 | 20 | 40 | 35 | 5 | 25:1 |
| 16 | 35 | 35 | 25 | 5 | 25:1 |
| 17 | 37.5 | 37.5 | 20 | 5 | 35:1 |
| 18 | 45 | 45 | 5 | 5 | 20:1 |
| 19 | 40 | 40 | 15 | 5 | 30:1 |
| 20 | 60 | 0 | 35 | 5 | 25:1 |
| 21 | 40 | 20 | 35 | 5 | 25:1 |
| 22 | 50 | 10 | 35 | 5 | 25:1 |
| 23 | 0 | 60 | 30 | 10 | 25:1 |
| 24 | 10 | 50 | 30 | 10 | 25:1 |
| 25 | 20 | 40 | 30 | 10 | 25:1 |
| 26 | 35 | 35 | 20 | 10 | 25:1 |
| 27 | 37.5 | 37.5 | 15 | 10 | 25:1 |
| 28 | 40 | 40 | 10 | 10 | 25:1 |
| 29 | 60 | 0 | 30 | 10 | 25:1 |
| 30 | 40 | 20 | 30 | 10 | 25:1 |
| 31 | 50 | 10 | 30 | 10 | 25:1 |
| 23 | 0 | 60 | 20 | 20 | 25:1 |
| 24 | 10 | 50 | 20 | 20 | 25:1 |
| 25 | 20 | 40 | 20 | 20 | 25:1 |
| 26 | 35 | 35 | 10 | 20 | 25:1 |
| 27 | 37.5 | 37.5 | 5 | 20 | 25:1 |
| 28 | 60 | 0 | 20 | 20 | 25:1 |
| 29 | 40 | 20 | 20 | 20 | 25:1 |
| 30 | 50 | 10 | 20 | 20 | 25:1 |

*OA = n-octyl acrylate; OMA = n-octyl methacrylate; EGDMA = ethylene glycol dimethacrylate; STY = styrene. Each oil phase further contains 5% by weight of the emulsifier.

These are nonlimiting examples of the compositions of the present invention. For example, decyl acylate, dodecyl acylate, or a mixture thereof can be substituted in whole or in part for n-octyl acrylate; and decyl methacylate, dodecyl methacylate, or a mixture thereof can be substituted in whole or in part for n-octyl methacrylate.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-in-oil emulsion comprising:
(A) an oil phase comprising:
(a) about 80 to about 99%, by weight, of a monomer component comprising:
(i) about 60% to about 98%, by weight, of a first substantially water-insoluble monomer selected from the group consisting of a C₂-C₁₈ alkyl acrylate, an aryl acrylate, a C₂-C₁₈ alkyl methacrylate, an aryl methacrylate, and mixtures thereof;
(ii) about 2% to about 40%, by weight, of a substantially water-insoluble polyfunctional crosslinker selected from the group consisting of an acrylate polyester, a methacrylate polyester, an acrylate methacrylate polyester, and a mixture thereof;
(iii) 0% to about 15%, by weight, of a second substantially water-insoluble monomer;
wherein at least one of the first substantially water-insoluble monomer (i), polyfunctional crosslinker (ii), or second substantially water-insoluble monomer (iii) exhibit a ¹⁴C/C ratio of about 1.0×10⁻¹³ or greater; and,
(b) about 1% to about 20%, by weight, of an emulsifier component which is miscible in the oil phase and suitable for forming a stable water-in-oil emulsion; and
(B) a water phase comprising about 0.2% to about 40%, by weight, of a water-soluble electrolyte;
wherein the emulsion has a volume to weight ratio of water phase to oil phase in the range of about 8:1 to about 140:1.

2. The emulsion of claim 1, wherein each of the first substantially water-insoluble monomer (i), polyfunctional crosslinker (ii), and second substantially water-insoluble monomer (iii) exhibit a ¹⁴C/C ratio of about 1.0×10⁻¹³ or greater.

3. The emulsion of claim 1, wherein at least one of the substantially water-insoluble monomer (i) or polyfunctional crosslinker (ii) exhibit a ¹⁴C/C ratio of about 1.0×10⁻¹² or greater.

4. The emulsion of claim 1, wherein the first water-insoluble monomer (i) is selected from the group consisting of a C₈-C₁₂ alkyl acrylate, an aryl acrylate, a C₈-C₁₂ methacrylate, an aryl methacrylate, and a mixture thereof.

5. The emulsion of claim 1, wherein the volume to weight ratio of water phase to oil phase is in the range of about 12:1 to about 65:1.

6. The emulsion of claim 5, wherein the volume to weight ratio of water phase to oil phase is in the range of about 18:1 to about 45:1.

7. The emulsion of claim 1, wherein the first substantially water-insoluble monomer (i) is selected from the group consisting of 2-ethylhexyl acrylate, 2-ethylhexyl methacrylate, n-butyl acrylate, n-butyl methacrylate, n-hexyl acrylate, n-hexyl methacrylate, n-octyl acrylate, n-octyl methacrylate, 2-octyl acrylate, 2-octyl methacrylate, n-nonyl acrylate, n-nonyl methacrylate, n-decyl acrylate, n-decyl methacrylate, isodecyl acrylate, isodecyl methacrylate, n-dodecyl acrylate, n-dodecyl methacrylate, n-tetradecyl acrylate, n-tetradecyl methacrylate, benzyl acrylate, benzyl methacrylate, nonylphenyl acrylate, nonylphenyl methacrylate, phenyl acrylate, phenyl methacrylate, cyclohexyl acrylate, cyclohexyl methacrylate, 6-methylheptyl acrylate, 6-methylheptyl methacrylate, 2-hydroxyethyl acrylate, 2-hydroxyethyl methacrylate, and a mixture thereof.

8. The emulsion of claim 7, wherein the first substantially water-insoluble monomer (i) is selected from the group consisting of 2-ethylhexyl acrylate, 2-ethylhexyl methacrylate, n-octyl acrylate, n-octyl methacrylate, 2-octyl acrylate, 2-octyl methacrylate, n-decyl acrylate, n-decyl methacrylate, n-dodecyl acrylate, n-dodecyl methacrylate, and a mixture thereof.

9. The emulsion of claim 1, wherein the polyfunctional crosslinker (ii) is selected from the group consisting of 1,6-hexanediol diacrylate, 1,4-butanediol acrylate, 1,4-butanediol dimethacrylate, trimethylolpropane triacrylate, trimethylolpropane trimethacrylate, 1,12-dodecyldimethacrylate, 1,14-tetradecanediol dimethacrylate, ethylene glycol dimethacrylate, ethylene glycol diacrylate, 2,2-dimethylpropanediol diacrylate, glucose pentaacrylate, sorbitan pentaacrylate, allyl acrylate, acrylate methacrylate, neopentyl glycol acrylate methacrylate, ethylene glycol acrylate methacrylate, 2,2-dimethylpropanediol acrylate methacrylate, hexanediol acrylate methacrylate, glycerol trimethacrylate, an acrylate or methacrylate derived from a sugar alcohol, and a mixture thereof.

10. The emulsion of claim 9, wherein the polyfunctional crosslinker (ii) comprises trimethylolpropane trimethacrylate, ethylene glycol dimethacrylate, glycerol trimethacrylate, or a mixture thereof.

11. The emulsion of claim 1, wherein the second substantially water insoluble monomer (iii) is selected from the group consisting of vinyl chloride, vinylidene chloride, styrene, divinyl benzene, ethylstyrene, chlorostyrene, and a mixture thereof.

12. The emulsion of claim 1, wherein the emulsifier component is selected from the group consisting of sorbitan monoesters of branched C₁₆-C₂₄ fatty acids, linear unsaturated C₁₆-C₂₂ fatty acids, linear saturated C₁₂-C₁₄ fatty acids, diglycerol monoesters of branched C₁₆-C₂₄ fatty acids, diglycerol monoesters of linear unsaturated C₁₆-C₂₂ fatty acids, diglycerol monoesters of linear saturated C₁₂-C₁₄ fatty acids, diglycerol monoaliphatic ethers of branched C₁₆-C₂₄ alcohols, diglycerol monoaliphatic ethers of linear unsaturated C₁₆-C₂₂ alcohols, diglycerol monoaliphatic ethers of linear saturated C₁₂-C₁₄ alcohols, polyglycerol succinates, phosphatidyl cholines, aliphatic betaines, long chain C₁₂-C₂₂ dialiphatic quaternary ammonium salts, short chain C₁-C₄ dialiphatic quaternary ammonium salts, long chain C₁₂-C₂₂ dialkoyl(alkenoyl)-2-hydroxyethyl quaternary ammonium salts, long chain C₁₂-C₂₂ dialiphatic imidazolinium quaternary ammonium salts, short chain C₁-C₄ dialiphatic quaternary ammonium salts, long chain C₁₂-C₂₂ monoaliphatic benzyl quaternary ammonium salts, long chain C₁₂-C₂₂ dialkoyl(alkenoyl)-2-aminoethyl quaternary ammonium salts, short chain C₁-C₄ monoaliphatic quaternary ammonium salts, short chain C₁-C₄ monohydroxyaliphatic quaternary ammonium salts, and a mixture thereof.

13. The emulsion of claim 12, wherein the emulsifier component is selected from the group consisting of isodecyl glycidyl ether, polyglycerol succinate, ditallow dimethyl ammonium methyl sulfate, and a mixture thereof.

14. The emulsion of claim 1, wherein the water phase further comprises a hydrosulfite.

15. The emulsion of claim 1, wherein the emulsion comprises
(i) about 60% to about 95%, by weight, of a monomer selected from the group consisting of a C₈-C₁₂ alkyl acrylate, an aryl acrylate, a C₈-C₁₂ alkyl methacrylate, an aryl methacrylate, and a mixture thereof;
(ii) about 2% to about 40%, by weight, of a polyfunctional crosslinker selected from the group consisting of polyfunctional acrylate, polyfunctional methacrylate, acrylate methacrylate, and a mixture thereof; and
about 3% to about 10%, by weight, of the emulsifier component; and,
about 1% to about 40% of the water soluble electrolyte in the water phase, wherein the electrolyte is an inorganic water soluble salt.

16. The emulsion of claim 1, wherein the emulsion has at least about 50 percent modern carbon (pMC; C¹⁴/C¹²×100%) based on the total weight of the emulsion.

17. A method for the preparation of a polymeric foam material comprising:
(A) forming the water-in-oil emulsion of claim 1; and,
(B) curing the monomer component in the oil phase of the water-in-oil emulsion at a sufficient curing temperature and for a sufficient time to form a polymeric foam material.

18. The method of claim 17, wherein the curing temperature is about 20° C. to about 130° C.

19. An article comprising a polymer derived from:
(i) a monomer selected from the group consisting of a C₂-C₁₈ alkyl acrylate, an aryl acrylate, a C₂-C₁₈ alkyl methacrylate, an aryl methacrylate, and a mixture thereof;
(ii) a polyfunctional crosslinker selected from the group consisting of an acrylate polyester, a methacrylate polyester, an acrylate methacrylate polyester, and a mixture thereof;
wherein at least one of the monomer or polyfunctional crosslinker exhibit a ¹⁴C/C ratio of about 1.0×10⁻¹³ or greater.

20. The article of claim 19 comprising a polymeric foam material, wherein the polymeric foam material has an expanded dry density of about 15 mg/cc to about 40 mg/cc
